(19) United States
(12) Patent Application Publication
(10) Pub. No.: US 2025/0024128 A1
(43) Pub. Date: Jan. 16, 2025

(54) CAMERA MODULE

(71) Applicant: Samsung Electro-Mechanics Co., Ltd., Suwon-si (KR)

(72) Inventors: Jae Ho BAIK, Suwon-si (KR); Young Ho KO, Suwon-si (KR); Phil Ho JUNG, Suwon-si (KR)

(73) Assignee: Samsung Electro-Mechanics Co., Ltd., Suwon-si (KR)

(21) Appl. No.: 18/767,154

(22) Filed: Jul. 9, 2024

(30) Foreign Application Priority Data
Jul. 12, 2023 (KR) 10-2023-0090721
Apr. 29, 2024 (KR) 10-2024-0056645

(51) Int. Cl. H04N 23/55; H04N 23/51; H04N 23/54; H04N 23/68

(52) U.S. Cl. CPC H04N 23/55; H04N 23/51; H04N 23/54; H04N 23/687

(57) ABSTRACT

A camera module includes a housing having an internal space; a reflective member disposed in the internal space; a lens barrel spaced apart from the reflective member, and configured to be movable relative to the reflective member in one or more of three axial directions intersecting each other; and an image sensor spaced apart from the reflective member, and including an imaging surface intersecting an optical axis direction, wherein the lens barrel and the image sensor are disposed closer to an object than the reflective member is, and are spaced apart from each other in a direction intersecting the optical axis direction.

### CROSS-REFERENCE TO RELATED APPLICATIONS

This application claims the benefit under 35 USC 119 (a) to Korean Patent Application Nos. 10-2023-0090721 filed on Jul. 12, 2023, and 10-2024-0056645 filed on Apr. 29, 2024, in the Korean Intellectual Property Office, the entire disclosures of which are incorporated herein by reference for all purposes.

### BACKGROUND

### 1. Field

The present disclosure relates to a camera module.

### 2. Description of Related Art

Recently, camera modules have been adopted for use in portable electronic devices such as smartphones, tablet PCs, and laptop PCs.

Furthermore, as a recently emerging structure, multiple camera modules having different angles of view have been mounted on portable electronic devices.

Among camera modules having different angles of view, a camera module having a small angle of view, such as a telephoto camera module, has a long total track length, which is difficult to apply to a portable electronic device with a limited mounting space.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In one general module, a camera module includes a housing having an internal space; a reflective member disposed in the internal space; a lens barrel spaced apart from the reflective member, and configured to be movable relative to the reflective member in one or more of three axial directions intersecting each other; and an image sensor spaced apart from the reflective member, and including an imaging surface intersecting an optical axis direction, wherein the lens barrel and the image sensor are disposed closer to an object than the reflective member is, and are spaced apart from each other in a direction intersecting the optical axis direction.

One surface of the housing may include one or more openings exposing the internal space to an outside of the housing, and the lens barrel and the image sensor may be disposed in the one or more openings.

The three axial directions may be the optical axis direction, a first axis direction perpendicular to the optical axis direction, and a second axis direction perpendicular to both the optical axis direction and the first axis direction, and the lens barrel and the image sensor may be spaced apart from the reflective member upward in the optical axis direction.

The camera module may further include a holder coupled to the lens barrel; a carrier accommodating the holder; and a focus adjustment unit configured to generate a driving force in the optical axis direction, and including a first magnet disposed on the carrier, and a first coil facing the first magnet.

A partial portion of the reflective member may be disposed inside the carrier.

A partial portion of the image sensor may be disposed inside the carrier.

At least a partial portion of the focus adjustment unit may be disposed to overlap the reflective member in a direction perpendicular to the optical axis direction.

A partial portion of the first magnet and a partial portion of the first coil may be disposed to overlap the reflective member in a direction in which the first magnet and the first coil face each other.

The camera module may further include a first ball member disposed between the carrier and the housing, wherein the first ball member may include a first ball group and a second ball group spaced apart from each other in a direction perpendicular to the optical axis direction, and a number of balls included in the first ball group may be greater than a number of balls included in the second ball group.

Either one or both of the first ball group and the second ball group may be disposed to overlap the reflective member in a direction perpendicular to the optical axis direction.

A first guide groove accommodating the first ball group and a second guide groove accommodating the second ball group may be formed in each of surfaces of the carrier and the housing facing each other, and a length of the first guide groove in the optical axis direction may be longer than a height of the reflective member in the optical axis direction.

The camera module may further include a holder coupled to the lens barrel; and an optical image stabilization unit configured to generate a driving force in a first axis direction and a second axis direction perpendicular to each other while intersecting the optical axis direction, and including a second magnet and a third magnet disposed on the holder, and a second coil and a third coil disposed on the housing.

At least a partial portion of the optical image stabilization unit may be disposed to overlap the reflective member in the first axis direction and in the second axis direction.

At least a partial portion of each of the second magnet and the second coil may be disposed to overlap the reflective member in a direction in which the second magnet and the second coil face each other, and at least a partial portion of each of the third magnet and the third coil may be arranged to overlap the reflective member in a direction in which the third magnet and the third coil face each other.

The optical image stabilization unit may be disposed to be higher than the reflective member in the optical axis direction.

At least a partial portion of a bottom surface of the housing facing the image sensor in the optical axis direction may be inclined with respect to the optical axis direction.

The reflective member may include an incident surface configured to receive incident light; a first reflection surface configured to reflect light having passed through the incident surface; a second reflection surface configured to reflect light reflected from the first reflection surface; a third reflection surface configured to reflect light reflected from the second reflection surface; and an emission surface configured to emit light reflected from the third reflection surface, and the incident surface, the second reflection surface, and the emission surface may be parts of one surface extending on a same plane.

The camera module may further include a carrier disposed inside the housing, wherein the lens barrel may be disposed inside the carrier, the carrier and the lens barrel may be configured to be movable together in a first axis direction perpendicular to the optical axis direction and in a second axis direction perpendicular to both the optical axis direction and the first axis direction, and the lens barrel may be configured to be movable relative to the carrier in the optical axis direction.

The camera module may further include a holder coupled to the lens barrel; a focus adjustment unit including a first magnet disposed in the holder, and a first coil facing the first magnet; and a connection substrate disposed on the carrier; wherein the connection substrate may include a mounting portion on which the first coil is disposed, a first extension portion bent from the mounting portion and extending along a side surface of the carrier, and a second extension portion bent from the first extension portion and extending to the outside of the housing, and the first extension portion may be made of a flexible material.

In another general aspect, a camera module includes a housing; a reflective member disposed in the housing, and including one surface intersecting an optical axis direction; a lens barrel spaced apart from a partial portion of the one surface of the reflective member, and configured to be movable relative to the reflective member in one or more of three axial directions intersecting each other; and an image sensor facing another partial portion of the one surface of the reflective member, and including an imaging surface intersecting the optical axis direction.

The reflective member may include an incident surface configured to receive light having passed through the lens barrel; a first reflection surface configured to reflect light having passed through the incident surface; a second reflection surface configured to reflect light reflected from the first reflection surface; a third reflection surface configured to reflect light reflected from the second reflection surface; and an emission surface configured to emit light reflected from the third reflection surface, and the incident surface, the second reflection surface, and the emission surface may be parts of the one surface of the reflective member.

At least a partial portion of a bottom surface of the housing facing the image sensor in the optical axis direction may be inclined with respect to the optical axis direction.

In another general aspect, a camera module includes a reflective member including one surface including an incident surface and an emission surface; a lens module having an optical axis intersecting the incident surface of the reflective member, the lens module being configured to receive light from an object and to be movable relative to the reflective member; and an image sensor including an imaging surface facing the emission surface of the reflective member, wherein the lens module and the image sensor are disposed between the reflective member and the object.

The reflective member may include at three reflective surfaces configured to reflect light from the lens module received through the incident surface to the imaging surface of the image sensor through the emission surface.

The camera module may further include a focus adjustment unit configured to move the lens module in a direction of the optical axis relative to the reflective member; and an optical image stabilization unit configured to move the lens module in a direction perpendicular to the optical axis.

At least a partial portion of the focus adjustment unit may be disposed to overlap the reflective member in a direction perpendicular to the optical axis.

The focus adjustment unit may be disposed between the reflective member and the object.

At least a partial portion of the optical image stabilization unit may be disposed to overlap the reflective member in a direction perpendicular to the optical axis.

The optical image stabilization unit may be disposed between the reflective member and the object.

Other features and aspects will be apparent from the following detailed description, the drawings, and the claims.

### BRIEF DESCRIPTION OF DRAWINGS

FIG. 1 is a perspective view of a camera module according to an embodiment of the present disclosure.

FIG. 2 is an exploded perspective view of the camera module of FIG. 1.

FIG. 3 is a perspective view of a modification of a housing of the camera module of FIGS. 1 and 2.

FIG. 4 is a partial exploded perspective view of the camera module of FIGS. 1 and 2.

FIG. 5 is a side view of a carrier of FIGS. 2 and 4.

FIG. 6 is a partial exploded perspective view of the camera module of FIGS. 1, 2, and 4.

FIG. 7 is a cross-sectional perspective view taken along the line VII-VII′ in FIG. 1.

FIG. 8 is a cross-sectional perspective view taken along the line VIII-VIII′ in FIG. 1.

FIG. 9 is a schematic cross-sectional view of the camera module of FIGS. 1 and 2.

FIG. 10 is a perspective view illustrating a state in which an image sensor module is separated from the camera module of FIG. 1 and illustrated in a bottom perspective view.

FIG. 11 is an exploded perspective view of the image sensor module of FIG. 10.

FIG. 12 is a cross-sectional view of a reflective member of FIG. 2.

FIG. 13 is a cross-sectional view of a modification of the reflective member of FIG. 12.

FIG. 14 is a schematic cross-sectional view of a modification of the camera module of FIG. 9.

FIG. 15 is an exploded perspective view of a camera module according to another embodiment of the present disclosure.

FIG. 16 is a perspective view of a camera module according to another embodiment of the present disclosure.

FIG. 17 is an exploded perspective view of the camera module of FIG. 16.

FIG. 18 is a partially exploded perspective view of the camera module of FIGS. 16 and 17.

FIG. 19 is a side view of a carrier of FIGS. 17 and 18.

FIG. 20 is a cross-sectional view of a housing of FIGS. 17 and 18 taken along the line XX-XX′ in FIG. 18.

FIG. 21 is an exploded perspective view illustrating a carrier, a guide frame, and a holder of FIG. 17.

FIG. 22 is a perspective view illustrating a state in which a case and an image sensor module are separated from the camera module of FIG. 16 and the image sensor module is illustrated in a bottom perspective view.

FIG. 23 is a schematic cross-sectional view of the camera module of FIG. 16.

FIG. 24 is an exploded perspective view of a camera module according to another embodiment of the present disclosure;

FIG. 25 is an exploded perspective view of a camera module according to another embodiment of the present disclosure.

FIG. 26 is a plan view of a connection substrate of the camera module of FIG. 25.

FIG. 27 is a perspective view of a camera module according to another embodiment of the present disclosure;

FIG. 28 is an exploded perspective view of the camera module of FIG. 27.

Throughout the drawings and the detailed description, the same reference numerals refer to the same elements. The drawings may not be to scale, and the relative sizes, proportions, and depictions of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated by 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

In the present specification, an optical axis (Z-axis) direction may be a direction extending up and down an optical axis (Z-axis) of a lens barrel 210 or a direction parallel to the optical axis (Z-axis).

A first axis (X-axis) direction and a second axis (Y-axis) direction may be directions perpendicular to each other while intersecting the optical axis (Z-axis) direction. For example, the first axis (X-axis) direction may be a direction perpendicular to the optical axis (Z-axis) direction, and the second axis (Y-axis) direction may be a direction perpendicular to both the optical axis (Z-axis) direction and the first axis (X-axis) direction.

The present disclosure relates to a camera module, and the camera module may be mounted in a portable electronic device such as a mobile communication terminal, a smartphone, and a tablet PC.

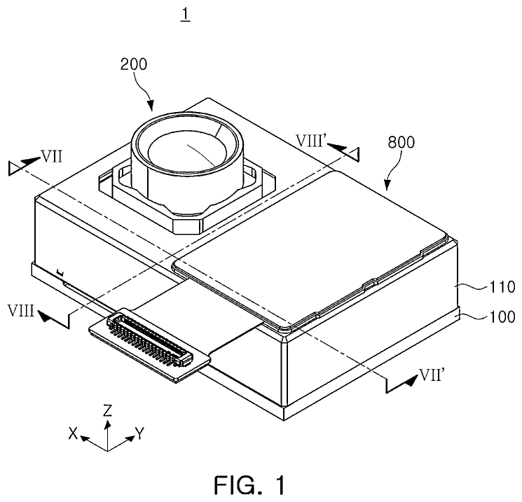

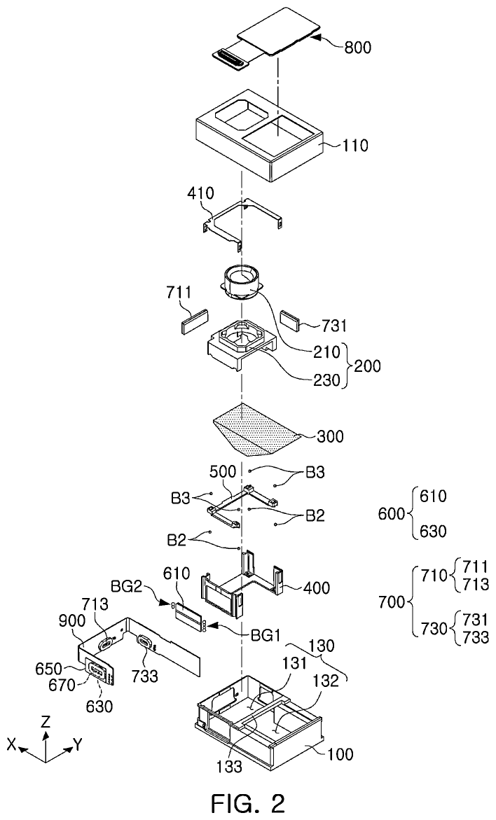

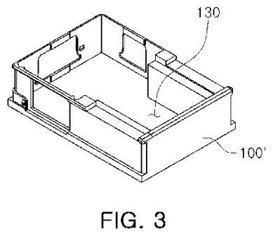

FIG. 1 is a perspective view of a camera module according to an embodiment of the present disclosure, FIG. 2 is an exploded perspective view of the camera module of FIG. 1, and FIG. 3 is a perspective view of a modification of a housing of the camera module of FIGS. 1 and 2.

Referring to FIGS. 1 and 2, a camera module 1 according to an embodiment of the present disclosure includes a lens module 200, a reflective member 300, and a housing 100.

The lens module 200 may include a lens barrel 210 and a holder 230. The lens barrel 210 may have a hollow cylindrical shape, and at least one lens for imaging a subject may be accommodated inside the lens barrel 210. In a case in which a plurality of lenses are arranged, the plurality of lenses may be mounted inside the lens barrel 210 along the optical axis (Z-axis).

The lens barrel 210 may be moved in one or more of three axial directions intersecting each other.

The lens barrel 210 may be coupled to the holder 230. The lens barrel 210 and the holder 230 may be movable together.

The housing 100 may have an internal space. In an embodiment, the housing 100 may be shaped like a rectangular box. One or more openings 130 may be formed in one surface of the housing 100. The internal space of the housing 100 may be exposed to the outside of the housing 100 through the openings 130. The one surface of the housing 100 may be an upper surface of the housing 100 as shown in FIG. 2.

In an embodiment, the one or more openings 130 formed in the one surface of the housing 100 may include a first opening 131 and a second opening 132. The first opening 131 and the second opening 132 may be arranged to be spaced apart from each other in a direction intersecting the optical axis (Z-axis). A partition wall 133 may be disposed between the first opening 131 and the second opening 132 as shown in FIG. 2.

The lens barrel 210 may be disposed in the first opening 131, and an image sensor module 800 may be disposed in the second opening 132.

Referring to FIG. 3, in another embodiment, one opening 130 may be formed in one surface of a housing 100′. Unlike the housing 100 illustrated in FIG. 2, the housing 100′ may have one opening 130 formed in one surface thereof by not forming the partition wall 133 in the housing 100′.

The reflective member 300 may disposed in the internal space of the housing 100. In addition, the lens barrel 210 of the lens module 200 may be disposed in front of the reflective member 300. Here, the expression “in front of” may refer to a positive optical axis (Z-axis) direction (+Z-axis direction) with respect to the reflective member 300. For example, the lens barrel 210 may be spaced apart from the reflective member 300 upward in the optical axis (Z-axis) direction.

Therefore, light may be incident on the reflective member 300 after passing through the lens barrel 210.

The lens module 200 may be moved in one or more of the three axial directions intersecting each other. In addition, the lens module 200 may be moved relative to the reflective member 300.

For example, the lens module 200 may be moved in the optical axis (Z-axis) direction for focus adjustment. In addition, the lens module 200 may be moved in a direction perpendicular to the optical axis (Z-axis) for optical image stabilization.

In an embodiment, the three axial directions intersecting each other may be the optical axis (Z-axis) direction, the first axis (X-axis) direction, and the second axis (Y-axis) direction.

The camera module 1 may further include a carrier 400 and a guide frame 500.

The carrier 400 may be disposed inside the housing 100, and may be moved relative to the housing 100 in the optical axis (Z-axis) direction. Since the reflective member 300 is fixed to the housing 100, the carrier 400 may also be moved relative to the reflective member 300.

The lens module 200 may be disposed on the carrier 400, and the carrier 400 and the lens module 200 may be movable together in the optical axis (Z-axis) direction. Accordingly, the camera module 1 may adjust a focus.

In addition, the lens module 200 may be moved in a direction perpendicular to the optical axis (Z-axis) direction to stabilize an optical image.

The guide frame 500 may be disposed between the carrier 400 and the lens module 200. The guide frame 500 may function to guide the lens module 200 to be moved in a direction perpendicular to the optical axis (Z-axis) direction.

The guide frame 500 may be a rectangular frame having an opening in the optical axis (Z-axis) direction, with one side being open. In an embodiment, the planar shape of the guide frame 500 may be approximately a ‘⊏’ shape. At least a partial portion of the reflective member 300 may be located on one side of the guide frame 500 that is open. As a result, the guide frame 500 and the reflective member 300 can be prevented from interfering with each other.

In another embodiment, the guide frame 500 may be a rectangular frame with two sides being open. In this case, the planar shape of the guide frame 500 may be approximately a′¬′ shape.

At least a partial portion of the lens module 200 may be accommodated in the housing 100. In an embodiment, the carrier 400 may be disposed inside the housing 100, and the lens module 200 may be accommodated inside the carrier 400. At least a partial portion of the lens barrel 210 may protrude out of the housing 100.

In addition, the lens module 200 may be disposed in the first opening 131 formed in the one surface of the housing 100.

The camera module 1 may adjust a focus by moving the lens module 200 in the optical axis (Z-axis) direction, and may stabilize an optical image at the time of capturing the image by moving the lens module 200 in a direction perpendicular to the optical axis (Z-axis).

The camera module 1 may further include a focus adjustment unit 600 moving the lens module 200 in the optical axis (Z-axis) direction, and an optical image stabilization unit 700 moving the lens module 200 in a direction perpendicular to the optical axis (Z-axis) direction.

The camera module 1 may further include the image sensor module 800 and a case 110.

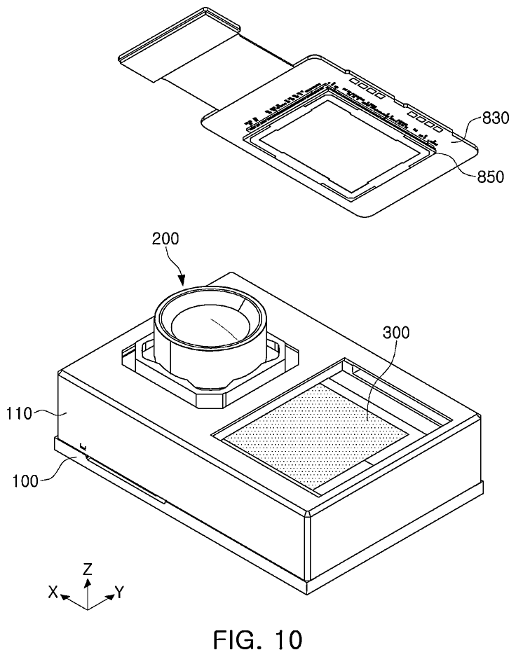

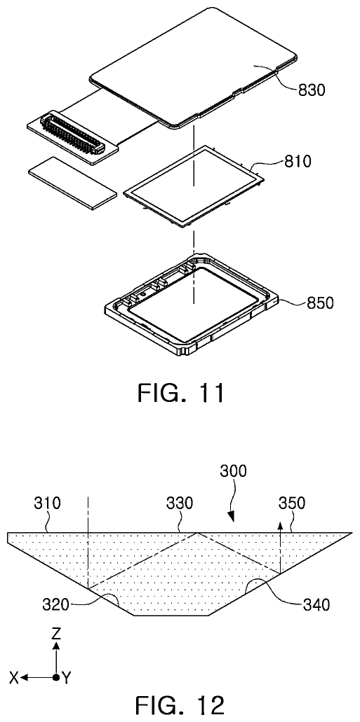

FIG. 10 is a perspective view illustrating a state in which an image sensor module is separated from the camera module of FIG. 1 and illustrated in a bottom perspective view, and FIG. 11 is an exploded perspective view of the image sensor module of FIG. 10.

Referring to FIGS. 10 and 11, the image sensor module 800 may include an image sensor 810 and a printed circuit board 830 connected to the image sensor 810, and may further include a sensor housing 850.

The image sensor 810 may convert light incident through the lens module 200 into an electric signal. As an example, the image sensor 810 may be a charge-coupled device (CCD) or a complementary metal-oxide-semiconductor (CMOS) device.

The electric signal converted by the image sensor 810 may be output as an image through a display unit of a portable electronic device in which the camera module 1 is mounted.

The image sensor 810 may be fixed to the printed circuit board 830, and may be electrically connected to the printed circuit board 830 by wire bonding.

The image sensor 810 may have an imaging surface on which light is received, and the imaging surface of the image sensor 810 may be a surface intersecting the optical axis (Z-axis) direction. The image sensor 810 may be disposed to be spaced apart from the reflective member 300. For example, the image sensor 810 may be spaced apart from the reflective member 300 upwardly in the optical axis (Z-axis) direction.

In an embodiment, both the lens barrel 210 and the image sensor 810 may be disposed to be higher than the reflective member 300 in the optical axis (Z-axis) direction. For example, the lens barrel 210 and the image sensor 810 may be disposed closer to an object than the reflective member 300 is. That is, among the lens barrel 210, the image sensor 810, and the reflective member 300, the lens barrel 210 and the image sensor 810 may be the closest ones to the object, and the reflective member 300 may be the farthest one from the object.

The image sensor module 800 may be mounted in the housing 100. As an example, the image sensor module 800 may be disposed in the second opening 132 formed in the one surface of the housing 100.

In an embodiment, the sensor housing 850 may be coupled to the printed circuit board 830, and the image sensor 810 may be disposed in an internal space of the sensor housing 850. In addition, either one or both of the sensor housing 850 and the printed circuit board 830 may be coupled to the housing 100.

The lens barrel 210 of the lens module 200 and the image sensor 810 of the image sensor module 800 may be respectively disposed in the first opening 131 and the second opening 132 of the housing 100, and may be disposed to be spaced apart from each other in a direction (e.g., the first axis (X-axis) direction) intersecting the optical axis (Z-axis) direction.

The case 110 may be coupled to the housing 100 to cover an outer surface of the housing 100, and may function to protect the components inside the camera module 1.

The reflective member 300 may have one surface facing in the optical axis (Z-axis) direction. The one surface of the reflective member 300 may be a surface intersecting the optical axis (Z-axis) direction. As an example, the one surface of the reflective member 300 may be an upper surface of the reflective member 300 as shown in FIG. 2.

The lens barrel 210 and the image sensor 810 may be disposed closer to an object than the reflective member 300 is, and may be spaced apart from each other in a direction intersecting the optical axis (Z-axis) direction. That is, among the lens barrel 210, the image sensor 810, and the reflective member 300, the lens barrel 210 and the image sensor 810 may be the closest ones to the object, and the reflective member 300 may be the farthest one from the object.

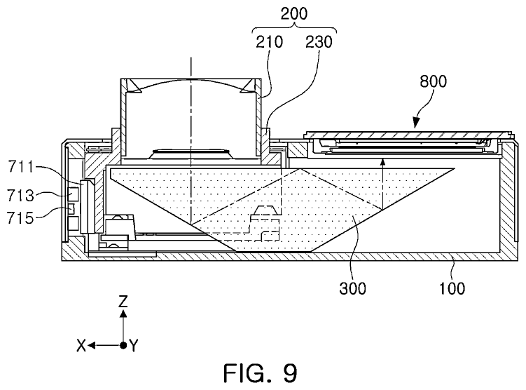

FIG. 9 is a schematic cross-sectional view of the camera module of FIGS. 1 and 2.

Referring to FIG. 9, in an embodiment, the lens barrel 210 may face a partial portion of the one surface (e.g., the upper surface) of the reflective member 300, and the image sensor 810 may face another partial portion of the one surface (e.g., the upper surface) of the reflective member 300.

The reflective member 300 may have one or more reflection surfaces. Since light having passed through the lens module 200 enters the image sensor 810 after being reflected by the reflective member 300, a long optical path can be formed within a limited space.

In addition, since the lens barrel 210 is disposed in front of the reflective member 300, the Fno (the F-number of the camera module 1) can be reduced to capture a bright image.

FIG. 12 is a cross-sectional view of a reflective member of FIG. 2.

Referring to FIG. 12, in an embodiment, the reflective member 300 may be in the form of a trapezoidal prism. The reflective member 300 may include an incident surface 310 on which light is incident, a first reflection surface 320 reflecting light having passed through the incident surface 310, a second reflection surface 330 reflecting light reflected from the first reflection surface 320, a third reflection surface 340 reflecting light reflected from the second reflection surface 330, and an emission surface 350 from which light reflected from the third reflection surface 340 is emitted. Light having passed through the emission surface 350 may be incident on the image sensor 810.

The image sensor 810 being disposed closer to the object than the reflective member 300 is may mean that the image sensor 810 is disposed closer to the object than the emission surface 350 of the reflective member 300 is.

In an embodiment, the incident surface 310, the second reflection surface 330, and the emission surface 350 may be one surface extending on the same plane. For example, the incident surface 310, the second reflection surface 330, and the emission surface 350 may be portions of the one surface of the reflective member 300.

Each of the first reflection surface 320 and the third reflection surface 340 may be inclined with respect to the second reflection surface 330.

A partial portion of the reflective member 300 may be disposed in the internal space of the carrier 400. In an embodiment, the incident surface 310 and the first reflection surface 320 of the reflective member 300 may be disposed in the internal space of the carrier 400.

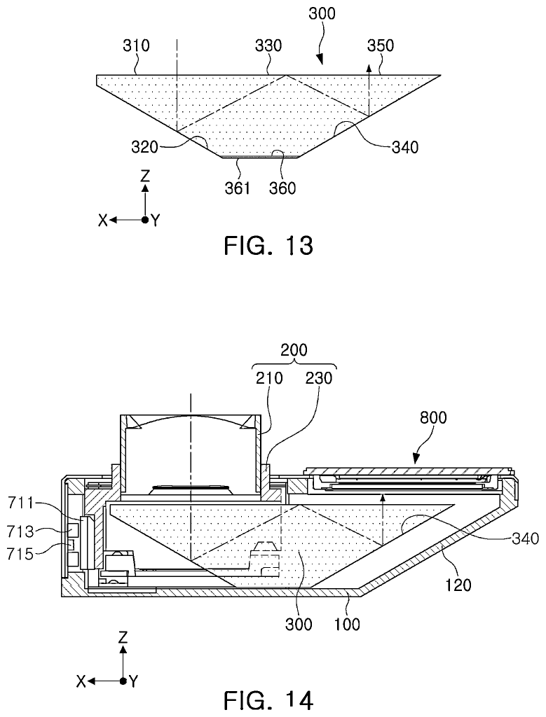

FIG. 13 is a cross-sectional view of a modification of the reflective member of FIG. 12.

Referring to FIG. 13, the reflective member 300 may include a bottom surface 360 connecting the first reflection surface 320 and the third reflection surface 340 to each other. An area of the bottom surface 360 may be smaller than an area of the upper surface of the reflective member 300 (e.g., an area of the incident surface 310+an area of the second reflection surface 330+an area of the emission surface 350). In addition, a light blocking part 361 may be disposed on the bottom surface 360. The light blocking part 361 may be made of a black material. As a result, unintended diffuse reflection of light can be suppressed inside the reflective member 300.

FIG. 14 is a schematic cross-sectional view of a modification of the camera module of FIG. 9.

Referring to FIG. 14, at least a partial portion 120 of a bottom surface of the housing 100 facing the image sensor 810 in the optical axis (Z-axis) direction may be inclined with respect to the optical axis (Z-axis) direction. That is, at least a partial portion 120 of the bottom surface of the housing 100 may be an inclined surface.

At least a partial portion of the third reflection surface 340 may be located between the inclined surface of the housing 100 and the image sensor 810. The third reflection surface 340 and the inclined surface of the housing 100 may be parallel to each other. For example, an inclination angle of the third reflection surface 340 with respect to the optical axis (Z-axis) direction and an inclination angle of the inclined surface of the housing 100 with respect to the optical axis (Z-axis) direction may be the same.

By making at least a partial portion 120 of the bottom surface of the housing 100 inclined, it is possible to provide a degree of freedom in installing components in the portable electronic device in which the camera module 1 is mounted. For example, since at least a partial portion 120 of the bottom surface of the housing 100 is inclined, other components to be installed in the portable electronic device can be mounted in a space formed by the inclination of the inclined surface. Accordingly, the size of the portable electronic device can be further reduced.

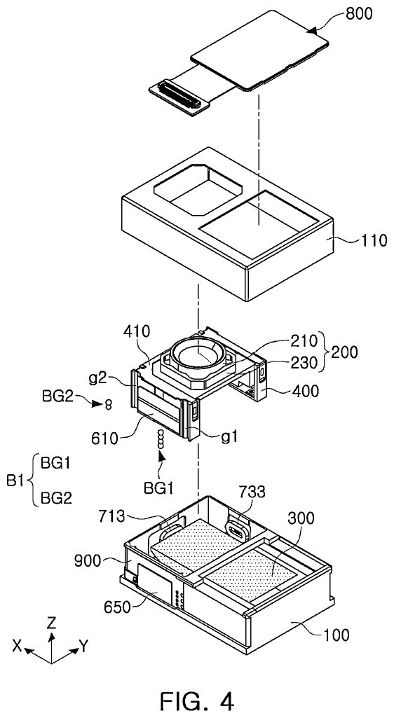

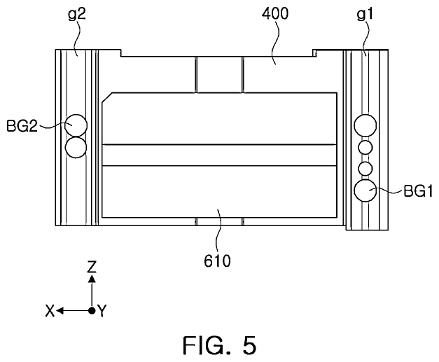

FIG. 4 is a partial exploded perspective view of the camera module of FIGS. 1 and 2, and FIG. 5 is a side view of a carrier of FIGS. 2 and 4.

The camera module 1 may move the lens module 200 to focus on a subject. To this end, the camera module 1 may include a focus adjustment unit 600.

The focus adjustment unit 600 may move the carrier 400 by generating a driving force in the optical axis (Z-axis) direction. Since the lens module 200 is disposed on the carrier 400, the carrier 400 and the lens module 200 may be moved together in the optical axis (Z-axis) direction by the driving force generated by the focus adjustment unit 600. In addition, since the guide frame 500 is disposed on the carrier 400, the guide frame 500 may be moved together with the carrier 400 in the optical axis (Z-axis) direction.

The focus adjustment unit 600 may include a first magnet 610 and a first coil 630. The first magnet 610 and the first coil 630 may be disposed to face each other in a direction perpendicular to the optical axis (Z-axis).

The first magnet 610 may be mounted on the carrier 400. As an example, the first magnet 610 may be mounted on one side surface of the carrier 400.

One surface (e.g., a surface facing the first coil 630) of the first magnet 610 may be magnetized to have both an N pole and an S pole. As an example, an N pole, a neutral region, and an S pole may be sequentially provided along the optical axis (Z-axis) direction on the one surface of the first magnet 610 facing the first coil 630.

The first coil 630 may be disposed to face the first magnet 610. For example, the first coil 630 may be disposed to face the first magnet 610 in a direction perpendicular to the optical axis (Z-axis).

The first coil 630 may be disposed on a substrate 900, and the substrate 900 may be mounted on the housing 100 in such a manner that the first magnet 610 and the first coil 630 face each other in a direction perpendicular to the optical axis (Z-axis). As an example, the first coil 630 may be disposed on one surface of the substrate 900. The substrate 900 may be mounted on a side surface of the housing 100 in such a manner that the first magnet 610 and the first coil 630 face each other in a direction perpendicular to the optical axis (Z-axis).

The housing 100 may have a through-hole penetrating the housing 100, and the first coil 630 disposed on the substrate 900 may directly face the first magnet 610 through the through-hole.

At the time of adjusting a focus, the first magnet 610 may be a movable member mounted on the carrier 400 and moving in the optical axis (Z-axis) direction together with the carrier 400, and the first coil 630 may be a fixed member fixed to the substrate 900.

When power is applied to the first coil 630, the carrier 400 may be moved in the optical axis (Z-axis) direction by an electromagnetic force generated between the first magnet 610 and the first coil 630.

Since the lens module 200 is disposed on the carrier 400, the lens module 200 may also be moved in the optical axis (Z-axis) direction by the movement of the carrier 400.

A first ball member B1 may be disposed between the carrier 400 and the housing 100. For example, the first ball member B1 may be disposed between the carrier 400 and the housing 100 to reduce friction when the carrier 400 is moved.

The first ball member B1 may include a plurality of balls arranged along the optical axis (Z-axis) direction. The plurality of balls may be moved in a rolling manner in the optical axis (Z-axis) direction when the carrier 400 is moved in the optical axis (Z-axis) direction.

The first ball member B1 may include a first ball group BG1 and a second ball group BG2, and each of the first ball group BG1 and the second ball group BG2 may include one or more balls. The first ball group BG1 and the second ball group BG2 may be disposed to be spaced apart from each other in a direction perpendicular to the optical axis (Z-axis).

A first yoke 650 may be disposed on the housing 100. The first yoke 650 may be disposed at a position facing the first magnet 610. For example, the first coil 630 may be disposed on one surface of the substrate 900, and the first yoke 650 may be disposed on the other surface of the substrate 900.

The first magnet 610 and the first yoke 650 may generate an attractive force therebetween. For example, the first yoke 650 may be made of a magnetic material. The attractive force may act in a direction perpendicular to the optical axis (Z-axis) between the first magnet 610 and the first yoke 650.

The first ball member B1 may be held in contact with each of the carrier 400 and the housing 100 due to the attractive force between the first magnet 610 and the first yoke 650.

Guides grooves may be formed in each of the surfaces of the carrier 400 and the housing 100 facing each other. For example, a first guide groove g1 accommodating the first ball group BG1 and a second guide groove g2 accommodating the second ball group BG2 may be formed in each of the surfaces of the carrier 400 and the housing 100 facing each other.

Each of the first guide groove g1 and the second guide groove g2 may extend in the optical axis (Z-axis) direction.

The first ball group BG1 and the second ball group BG2 may be disposed to be spaced apart from each other in the first axis (X-axis) direction. The number of balls in the first ball group BG1 and the number of balls in the second ball group BG2 may be different. Specifically, the number of balls included in the first ball group BG1 may be greater than the number of balls included in the second ball group BG2.

For example, the first ball group BG1 may include two or more balls disposed along the optical axis (Z-axis) direction, and the second ball group BG2 may include a smaller number of balls than the number of balls included in the first ball group BG1.

On the premise that the number of balls belonging to the first ball group BG1 and the number of balls belonging to the second ball group BG2 are different, the number of balls belonging to each ball group may be changed. Hereinafter, for convenience of explanation, the description will be made based on an embodiment in which the first ball group BG1 includes four balls and the second ball group BG2 includes two balls.

Among the four balls included in the first ball group BG1, the two outermost balls in the optical axis (Z-axis) direction may have the same diameter, and the two balls disposed between the outermost balls may have a smaller diameter than the outermost balls.

The two balls included in the second ball group BG2 may have the same diameter.

Among the four balls included in the first ball group BG1, each of the two outermost balls in the optical axis (Z-axis) direction may be in contact with the carrier 400 at two points and in contact with the housing 100 at two points.

Each of the two balls in the second ball group BG2 may be in contact with the carrier 400 at one point and in contact with the housing 100 at two points (or vice versa).

The first ball group BG1 and the first guide groove g1 may function as a main guide that guides a movement of the carrier 400 in the optical axis (Z-axis) direction, and the second ball group BG2 and the second guide groove g2 may function as an auxiliary guide that supports a movement of the carrier 400 in the optical axis (Z-axis) direction.

A length of the first guide groove g1 in the optical axis (Z-axis) direction may be longer than a height of the reflective member 300 in the optical axis (Z-axis) direction.

Either one or both of the first ball group BG1 and the second ball group BG2 may be disposed to overlap the reflective member 300 in a direction perpendicular to the optical axis (Z-axis) direction. For example, the first ball group BG1 may be disposed to overlap the reflective member 300 in the second axis (Y-axis) direction.

In an embodiment, an auxiliary yoke (not shown) may be disposed at a position facing the first magnet 610. For example, the auxiliary yoke may be disposed on the substrate 900 to face the first magnet 610. In addition, the auxiliary yoke may be disposed on an inner side of the first coil 630.

The auxiliary yoke may be located closer to the first ball group BG1 than to the second ball group BG2. The auxiliary yoke may be made of a material capable of generating an attractive force with the first magnet 610.

Accordingly, a central point of a resultant force of the attractive force generated between the first magnet 610 and the first yoke 650 and the attractive force generated between the first magnet 610 and the auxiliary yoke may be located closer to the first ball group BG1 than to the second ball group BG2.

In an embodiment, the camera module 1 may detect a position of the carrier 400 in the optical axis (Z-axis) direction.

To this end, a first position sensor 670 may be provided. The first position sensor 670 may be disposed on the substrate 900 to face the first magnet 610. The first position sensor 670 may be a Hall sensor.

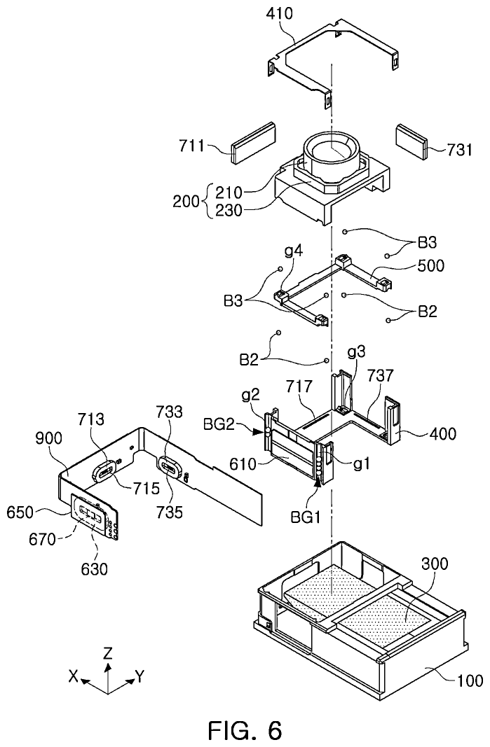

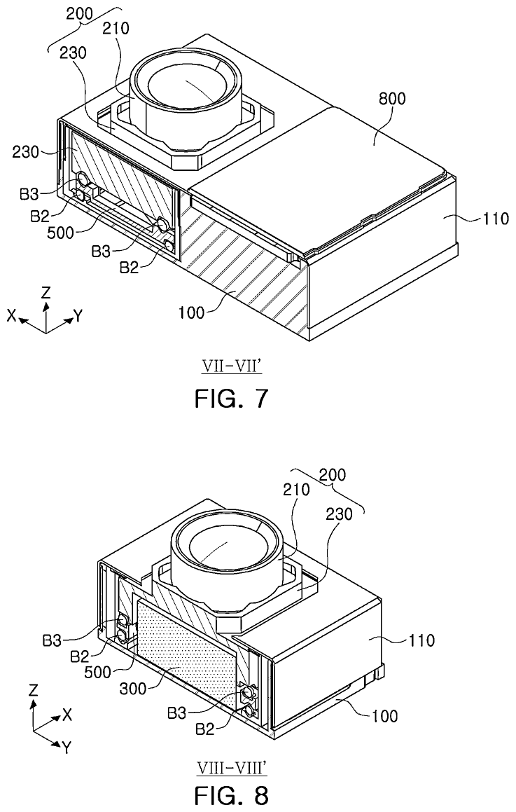

FIG. 6 is a partial exploded perspective view of the camera module of FIGS. 1, 2, and 4, FIG. 7 is a cross-sectional perspective view taken along the line VII-VII′ in FIG. 1, and FIG. 8 is a cross-sectional perspective view taken along the line VIII-VIII′ in FIG. 1.

The camera module 1 may stabilize an optical image at the time of capturing an image by moving the lens module 200 in a direction perpendicular to the optical axis (Z-axis). To this end, the camera module 1 may include an optical image stabilization unit 700 moving the lens module 200 in a direction perpendicular to the optical axis (Z-axis).

The guide frame 500 and the lens module 200 may be sequentially disposed in the carrier 400. For example, the guide frame 500 may be disposed between the carrier 400 and the lens module 200.

The guide frame 500 and the lens module 200 may be moved together in one direction perpendicular to the optical axis (Z-axis) by a driving force generated by the optical image stabilization unit 700, and the lens module 200 may be moved relative to the guide frame 500 in another direction perpendicular to the optical axis (Z-axis) by another driving force generated by the optical image stabilization unit 700.

For example, the guide frame 500 and the lens module 200 may be moved together in the first axis (X-axis) direction perpendicular to the optical axis (Z-axis), and the lens module 200 may be moved relative to the guide frame 500 in the second axis (Y-axis) direction perpendicular to both the optical axis (Z-axis) and the first axis (X-axis).

The optical image stabilization unit 700 may include a first sub-stabilization unit 710 and a second sub-stabilization unit 730. The first sub-stabilization unit 710 may generate a driving force in the first axis (X-axis) direction, and the second sub-stabilization unit 730 may generate a driving force in the second axis (Y-axis) direction.

The first sub-stabilization unit 710 may include a second magnet 711 and a second coil 713. The second magnet 711 and the second coil 713 may be disposed to face each other in the first axis (X-axis) direction.

The second magnet 711 may be disposed on the lens module 200. For example, the second magnet 711 may be mounted on one side surface of the holder 230.

One surface (e.g., a surface facing the second coil 713) of the second magnet 711 may be magnetized to have an N pole or an S pole. The second magnet 711 may have a length extending in the second axis (Y-axis) direction.

The other surface of the second magnet 711 may be magnetized to have a polarity opposite to the polarity of the one surface of the second magnet 711.

The second coil 713 may be disposed to face the second magnet 711. For example, the second coil 713 may be disposed to face the second magnet 711 in the first axis (X-axis) direction.

The second coil 713 may be disposed on the substrate 900, and the substrate 900 may be mounted on the housing 100 in such a manner that the second magnet 711 and the second coil 713 face each other in the first axis (X-axis) direction.

The housing 100 may have a through-hole penetrating the housing 100, and the second coil 713 disposed on the substrate 900 may directly face the second magnet 711 through the through-hole.

At the time of stabilizing an optical image, the second magnet 711 may be a movable member mounted on the lens module 200, and the second coil 713 may be a fixed member fixed to the housing 100.

When power is applied to the second coil 713, the lens module 200 and the guide frame 500 may be moved in the first axis (X-axis) direction by an electromagnetic force generated between the second magnet 711 and the second coil 713.

The second magnet 711 and the second coil 713 may generate a driving force in a direction in which they face each other (e.g., the first axis (X-axis) direction).

The second sub-stabilization unit 730 may include a third magnet 731 and a third coil 733. The third magnet 731 and the third coil 733 may be disposed to face each other in the second axis (Y-axis) direction.

The third magnet 731 may be disposed on the lens module 200. For example, the third magnet 731 may be mounted on another side surface of the holder 230.

One surface (e.g., a surface facing the third coil 733) of the third magnet 731 may be magnetized to have both an N pole and an S pole. The third magnet 731 may have a length extending in the first axis (X-axis) direction.

The other surface of the third magnet 731 may be magnetized to have a polarity opposite to the polarity of the one surface of the third magnet 731.

The third coil 733 may be disposed to face the third magnet 731. For example, the third coil 733 may be disposed to face the third magnet 731 in the second axis (Y-axis) direction.

The third coil 733 may be disposed on the substrate 900, and the substrate 900 may be mounted on the housing 100 in such a manner that the third magnet 731 and the third coil 733 face each other in the second axis (Y-axis) direction.

The housing 100 may have a through-hole penetrating the housing 100, and the third coil 733 disposed on the substrate 900 may directly face the third magnet 731 through the through-hole.

At the time of stabilizing an optical image, the third magnet 731 may be a movable member mounted on the lens module 200, and the third coil 733 may be a fixed member fixed to the housing 100.

When power is applied to the third coil 733, the lens module 200 may be moved in the second axis (Y-axis) direction by an electromagnetic force generated between the third magnet 731 and the third coil 733.

The third magnet 731 and the third coil 733 may generate a driving force in a direction in which they face each other (e.g., the second axis (Y-axis) direction).

The second magnet 711 and the third magnet 731 may be disposed perpendicular to each other on a plane perpendicular to the optical axis (Z-axis), and the second coil 713 and the third coil 733 may also be disposed perpendicular to each other on the plane perpendicular to the optical axis (Z-axis).

The camera module 1 according to an embodiment of the present disclosure may include a plurality of ball members supporting the guide frame 500 and the lens module 200. The plurality of ball members may function to guide movements of the guide frame 500 and the lens module 200 during an optical image stabilizing process. The plurality of ball members may also function to maintain gaps between the carrier 400, the guide frame 500, and the lens module 200.

The plurality of ball members may include a second ball member B2 and a third ball member B3. The second ball member B2 may be disposed between the carrier 400 and the guide frame 500, and the third ball member B3 may be disposed between the guide frame 500 and the lens module 200.

The second ball member B2 may guide movements of the guide frame 500 and the lens module 200 in the first axis (X-axis) direction, and the third ball member B3 may guide a movement of the lens module 200 in the second axis (Y-axis) direction.

As an example, the second ball member B2 may move in a rolling manner in the first axis (X-axis) direction when a driving force is generated in the first axis (X-axis) direction. Accordingly, the second ball member B2 may guide movements of the guide frame 500 and the lens module 200 in the first axis (X-axis) direction.

The third ball member B3 may move in a rolling manner in the second axis (Y-axis) direction when a driving force is generated in the second axis (Y-axis) direction. Accordingly, the third ball member B3 may guide a movement of the lens module 200 in the second axis (Y-axis) direction.

The second ball member B2 may include a plurality of balls disposed between the carrier 400 and the guide frame 500, and the third ball member B3 may include a plurality of balls disposed between the guide frame 500 and the lens module 200.

For example, each of the second ball member B2 and the third ball member B3 may include four balls.

A third guide groove g3 accommodating the second ball member B2 may be formed in either one or both of the surfaces of the carrier 400 and the guide frame 500 facing each other in the optical axis (Z-axis) direction. The third guide groove g3 may include a plurality of grooves corresponding to the plurality of balls of the second ball member B2.

The second ball member B2 may be accommodated in the third guide groove g3, and inserted between the carrier 400 and the guide frame 500.

In a state in which the second ball member B2 is accommodated in the third guide groove g3, the second ball member B2 may be moved only in the first axis (X-axis) direction, while its movements in the optical axis (Z-axis) direction and in the second axis (Y-axis) direction are restricted. As an example, the second ball member B2 may move in a rolling manner only in the first axis (X-axis) direction.

To this end, the planar shape of each of the plurality of grooves of the third guide groove g3 may be a rectangle having a length extending in the first axis (X-axis) direction.

A fourth guide groove g4 accommodating the third ball member B3 may be formed in either one or both of the surfaces of the guide frame 500 and the lens module 200 (e.g., the holder 230) facing each other in the optical axis (Z-axis) direction. The fourth guide groove g4 may include a plurality of grooves corresponding to the plurality of balls of the third ball member B3.

The third ball member B3 may be accommodated in the fourth guide groove g4, and inserted between the guide frame 500 and the lens module 200.

In a state in which the third ball member B3 is accommodated in the fourth guide groove g4, the third ball member B3 may be moved only in the second axis (Y-axis) direction, while its movements in the optical axis (Z-axis) direction and in the first axis (X-axis) direction are restricted. As an example, the third ball member B3 may move in a rolling manner only in the second axis (Y-axis) direction.

To this end, the planar shape of each of the plurality of grooves of the fourth guide groove g4 may be a rectangle having a length extending in the second axis (Y-axis) direction.

When a driving force generated in the first axis (X-axis) direction, the guide frame 500 and the lens module 200 may move together in the first axis (X-axis) direction. Here, the second ball member B2 may move in a rolling manner along the first axis (X-axis). At this time, a movement of the third ball member B3 may be restricted.

When a driving force is generated in the second axis (Y-axis) direction, the lens module 200 may be moved relative to the guide frame 500 in the second axis (Y-axis) direction. Here, the third ball member B3 may move in a rolling manner along the second axis (Y-axis). At this time, a movement of the second ball member B2 may be restricted.

In an embodiment, the camera module 1 may detect a position of the lens module 200 in a direction perpendicular to the optical axis (Z-axis).

To this end, a second position sensor 715 and a third position sensor 735 may be provided. The second position sensor 715 may be disposed on the substrate 900 to face the second magnet 711, and the third position sensor 735 may be disposed on the substrate 900 to face the third magnet 731. The second position sensor 715 and the third position sensor 735 may be Hall sensors.

In the present disclosure, a second yoke 717 and a third yoke 737 may be provided to keep the carrier 400 and the guide frame 500 in contact with the second ball member B2, and keep the guide frame 500 and the lens module 200 in contact with the third ball member B3.

The second yoke 717 and the third yoke 737 may be fixed to the carrier 400, and may be disposed to face the second magnet 711 and the third magnet 731 in the optical axis (Z-axis) direction.

Therefore, attractive forces may be generated in the optical axis (Z-axis) direction between the second yoke 717 and the second magnet 711 and between the third yoke 737 and the third magnet 731.

Due to the attractive force generated between the second yoke 717 and the second magnet 711 and the attractive force generated between the third yoke 737 and the third magnet 731, the lens module 200 and the guide frame 500 may be pressed in a direction toward the second yoke 717 and the third yoke 737, making it possible to keep the guide frame 500 and the lens module 200 in contact with the second ball member B2 and the third ball member B3.

The second yoke 717 and the third yoke 737 may be made of a material capable of generating an attractive force with the second magnet 711 and the third magnet 731. As an example, the second yoke 717 and the third yoke 737 may be made of a magnetic material.

A stopper 410 may be coupled to the carrier 400. The stopper 410 may be coupled to the carrier 400 to cover at least a partial portion of an upper surface of the lens module 200. For example, the stopper 410 may cover at least a partial portion of the upper surface of the holder 230.

The stopper 410 may prevent the guide frame 500 and the lens module 200 from separating from the carrier 400 due to an external shock or other disturbance.

A buffer member (not shown) having an elastic property may be coupled to an edge portion of the stopper 410.

In an embodiment, at least a partial portion of the focus adjustment unit 600 may be disposed to overlap the reflective member 300 in a direction perpendicular to the optical axis (Z-axis).

For example, a partial portion of the first magnet 610 and a partial portion of the first coil 630 may be disposed to overlap the reflective member 300 in a direction in which the first magnet 610 and the first coil 630 face each other.

At least a partial portion of the first magnet 610 may be disposed to be spaced apart from one side surface of the reflective member 300 in the second axis (Y-axis) direction. In addition, at least a partial portion of the first coil 630 may be disposed to be spaced apart from one side surface of the reflective member 300 in the second axis (Y-axis) direction. The one side surface of the reflective member 300 may have a trapezoidal shape in the second axis (Y-axis) direction.

In an embodiment, at least a partial portion of the optical image stabilization unit 700 may be disposed to overlap the reflective member 300 in a direction perpendicular to the optical axis (Z-axis).

For example, a partial portion of the second magnet 711 and a partial portion of the second coil 713 may be disposed to overlap the reflective member 300 in a direction in which the second magnet 711 and the second coil 713 face each other.

A partial portion of the third magnet 731 and a partial portion of the third coil 733 may be disposed to overlap the reflective member 300 in a direction in which the third magnet 731 and the third coil 733 face each other.

At least a partial portion of the second magnet 711 may be disposed to be spaced apart from the first reflection surface 320 of the reflective member 300 in the first axis (X-axis) direction. In addition, at least a partial portion of the second coil 713 may be disposed to be spaced apart from the first reflection surface 320 of the reflective member 300 in the first axis (X-axis) direction.

At least a partial portion of the third magnet 731 may be disposed to be spaced apart from another side surface of the reflective member 300 in the second axis (Y-axis) direction. In addition, at least a partial portion of the third coil 733 may be disposed to be spaced apart from the other side surface of the reflective member 300 in the second axis (Y-axis) direction. The other side surface of the reflective member 300 may have a trapezoidal shape in the second axis (Y-axis) direction.

Since each of at least a partial portion of the focus adjustment unit 600 and at least a partial portion of the optical image stabilization unit 700 is disposed to overlap the reflective member 300 in a direction perpendicular to the optical axis (Z-axis), the size (e.g., the height in the optical axis (Z-axis) direction) of the camera module 1 can be reduced.

One edge of the reflective member 300 may be chamfered. As a result, it is possible to prevent the one edge of the reflective member 300 from interfering with an inner side surface of the holder 230. The one edge of the reflective member 300 may be an edge where the incident surface 310 and the first reflection surface 320 are connected to each other as shown in FIGS. 12 and 13.

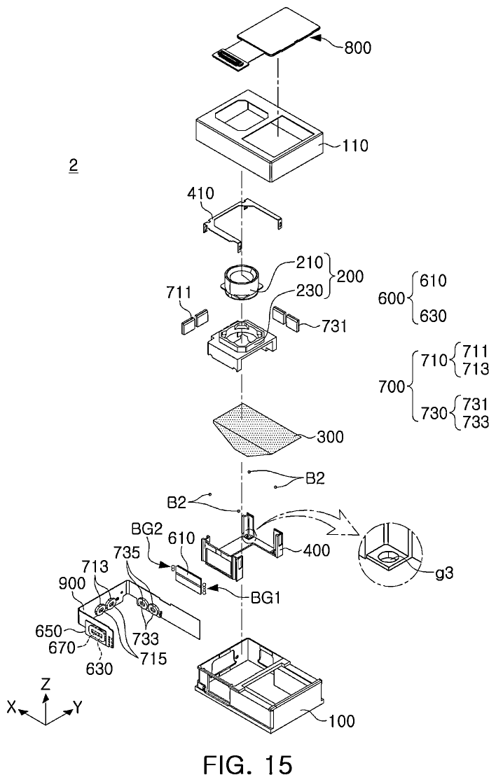

FIG. 15 is an exploded perspective view of a camera module according to another embodiment of the present disclosure.

When compared to the camera module 1 described with reference to FIGS. 1 to 14, a camera module 2 of FIG. 15 differs in whether the guide frame 500 is present and the configuration of the optical image stabilization unit 700.

For example, in the camera module 2 of FIG. 15, the guide frame 500 is not disposed between the carrier 400 and the lens module 200. In addition, since the guide frame 500 is not disposed, the third ball member B3 disposed between the guide frame 500 and the lens module 200 is also not provided.

The lens module 200 may be configured to be movable in the first axis (X-axis) direction and in the second axis (Y-axis) direction within the carrier 400.

The second ball member B2 may be disposed between the carrier 400 and the lens module 200. The second ball member B2 may be disposed to contact each of the carrier 400 and the lens module 200.

The second ball member B2 may function to guide the lens module 200 to be movable in two axial directions during an optical image stabilizing process. That is, the second ball member B2 may guide both a movement in the first axis (X-axis) direction and a movement in the second axis (Y-axis) direction of the lens module 200.

As an example, the second ball member B2 may move in a rolling manner in the first axis (X-axis) direction when a driving force is generated in the first axis (X-axis) direction. Accordingly, the second ball member B2 may guide a movement of the lens module 200 in the first axis (X-axis) direction.

In addition, the second ball member B2 may move in a rolling manner in the second axis (Y-axis) direction when a driving force is generated in the second axis (Y-axis) direction. Accordingly, the second ball member B2 may guide a movement of the lens module 200 in the second axis (Y-axis) direction.

A third guide groove g3 accommodating the second ball member B2 may be formed in either one or both of the surfaces of the carrier 400 and the lens module 200 facing each other in the optical axis (Z-axis) direction.

The second ball member B2 may be disposed in the third guide groove g3, and inserted between the carrier 400 and the lens module 200. In a state in which the second ball member B2 is accommodated in the third guide groove g3, the second ball member B2 may be moved in the first axis (X-axis) direction and in the second axis (Y-axis) direction, while its movement in the optical axis (Z-axis) direction is restricted. As an example, the second ball member B2 may move in a rolling manner in the first axis (X-axis) direction and in the second axis (Y-axis) direction.

The third guide groove g3 may be configured to have a circular cross-sectional shape when cut along a plane perpendicular to the optical axis (Z-axis) direction. A cross-sectional size of the third guide groove g3 may be larger than a diameter of the second ball member B2.

The second magnet 711 of the first sub-stabilization unit 710 may include two magnets, and the second coil 713 may include two coils. The two magnets may be disposed to be spaced apart from each other in the second axis (Y-axis) direction, and the two coils may also be disposed to be spaced apart from each other in the second axis (Y-axis) direction.

One of the two magnets may face one of the two coils, and the other one of the two magnets may face the other one of the two coils. Each of the two magnets may be magnetized in such a manner that one surface facing the third coil 733 thereof has one polarity. For example, one surface of one of the two magnets facing one of the two coils may have an N pole, and one surface of the other one of the two magnets facing the other one of the two coils may have an S pole.

In another embodiment, while the second coil 713 includes two coils, the second magnet 711 may include one magnet facing the two coils. In this case, one surface of the second magnet 711 facing the two coils may have both an N pole and an S pole, with the N pole facing one coil and the S pole facing the other coil.

The third magnet 731 of the second sub-stabilization unit 730 may include two magnets, and the third coil 733 may include two coils. The two magnets may be disposed to be spaced apart from each other in the first axis (X-axis) direction, and the two coils may also be disposed to be spaced apart from each other in the first axis (X-axis) direction.

One of the two magnets may face one of the two coils, and the other one of the two magnets may face the other one of the two coils. Each of the two magnets may be magnetized in such a manner that one surface facing the second coil 713 thereof has one polarity. For example, one surface of one of the two magnets facing one of the two coils may have an N pole, and one surface of the other one of the two magnets facing the other one of the two coils may have an S pole.

In another embodiment, while the third coil 733 includes two coils, the third magnet 731 may include one magnet facing the two coils. In this case, one surface of the third magnet 731 facing the two coils may have both an N pole and an S pole, with the N pole facing one coil and the S pole facing the other coil.

Through this configuration, a magnetic field leakage can be prevented and a sufficient driving force can be generated even at a low power.

In the present embodiment, since the second ball member B2 is movable in a rolling manner in the first axis (X-axis) direction and in the second axis (Y-axis) direction, when the lens module 200 is moved in the first axis (X-axis) direction and in the second axis (Y-axis) direction, there is a risk that the lens module 200 may be rotated on a plane perpendicular to the optical axis (Z-axis) due to a factor such as a variation between a driving force applied in the first axis (X-axis) direction and a driving force applied in the second axis (Y-axis) direction.

The camera module 2 of FIG. 15 may detect whether the lens module 200 is rotated. In addition, when the lens module 200 is rotated, the camera module 2 may generate a driving force capable of offsetting the rotation of the lens module 200.

Each of the second position sensor 715 and the third position sensor 735 may include two Hall sensors. When the lens module 200 is rotated, a distance between one of the two Hall sensors of the second position sensor 715 and the lens module 200 decreases, and a distance between the other one of the two Hall sensors of the second position sensor 715 and the lens module 200 increases (the same applies to the third position sensor 735).

Therefore, it is possible to determine whether the lens module 200 is rotated through the second position sensor 715 and the third position sensor 735.

In the camera module 2 of FIG. 15, the first sub-stabilization unit 710 may include a second coil 713 including two coils, and the second sub-stabilization unit 730 may include a third coil 733 including two coils. Accordingly, the first sub-stabilization unit 710 and the second sub-stabilization unit 730 may generate driving forces for offsetting the rotation of the lens module 200.

Although it has been described in the embodiment of FIG. 15 that each of the second position sensor 715 and the third position sensor 735 includes two Hall sensors, only one of the second position sensor 715 and the third position sensor 735 may include two Hall sensors.

Furthermore, only one of the first sub-stabilization unit 710 and the second sub-stabilization unit 730 may be configured to have the form illustrated in FIG. 15, and the other one may be configured to have the form illustrated in FIG. 2.

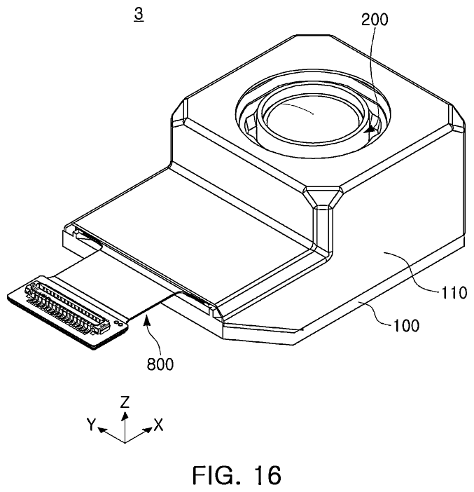

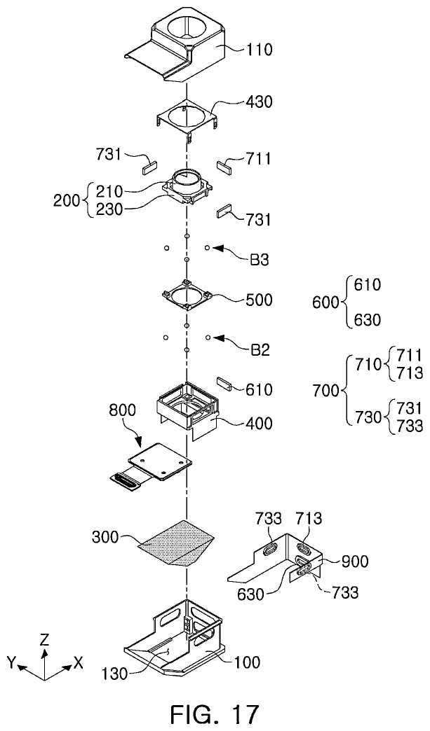

FIG. 16 is a perspective view of a camera module according to another embodiment of the present disclosure, and FIG. 17 is an exploded perspective view of the camera module of FIG. 16.

Referring to FIGS. 16 and 17, a camera module 3 according to another embodiment of the present disclosure may include a lens module 200, a reflective member 300, and a housing 100.

The lens module 200 may include a lens barrel 210 and a holder 230. The lens barrel 210 may have a hollow cylindrical shape, and at least one lens for imaging a subject may be accommodated inside the lens barrel 210. In a case in which a plurality of lenses are arranged, the plurality of lenses may be mounted inside the lens barrel 210 along the optical axis (Z-axis).

The lens barrel 210 may be coupled to the holder 230. The lens barrel 210 and the holder 230 may be movable together.

The housing 100 may have an internal space. In an embodiment, the housing 100 may be shaped like a rectangular box. An opening 130 may be formed in one surface of the housing 100. The internal space of the housing 100 may be exposed to the outside of the housing 100 through the opening 130. The one surface of the housing 100 may be an upper surface of the housing 100 as shown in FIG. 17.

The reflective member 300 may disposed in the internal space of the housing 100. In addition, the lens module 200 may be disposed in front of the reflective member 300. Here, the expression “in front of” may refer to a positive optical axis (Z-axis) direction (+Z-axis direction) with respect to the reflective member 300. For example, the lens module 200 may be spaced apart from the reflective member 300 upward in the optical axis (Z-axis) direction.

Therefore, light may be incident on the reflective member 300 after passing through the lens module 200.

The lens module 200 may be moved in one or more of three axial directions intersecting each other. In addition, the lens module 200 may be moved relative to the reflective member 300.

For example, the lens module 200 may be moved in the optical axis (Z-axis) direction for focus adjustment. In addition, the lens module 200 may be moved in a direction perpendicular to the optical axis (Z-axis) for optical image stabilization.

In an embodiment, the three axial directions intersecting each other may be the optical axis (Z-axis) direction, the first axis (X-axis) direction, and the second axis (Y-axis) direction.

The camera module 3 may further include a carrier 400 and a guide frame 500.

The carrier 400 may be disposed inside the housing 100, and may be moved relative to the housing 100 in the optical axis (Z-axis) direction.

The lens module 200 may be disposed on the carrier 400, and the carrier 400 and the lens module 200 may be movable together in the optical axis (Z-axis) direction. Accordingly, the camera module 3 may adjust a focus.

In addition, the lens module 200 may be movable in a direction perpendicular to the optical axis (Z-axis) direction to stabilize an optical image at the time of capturing the image.

The guide frame 500 may be disposed between the carrier 400 and the lens module 200. The guide frame 500 may function to guide the lens module 200 to be movable in a direction perpendicular to the optical axis (Z-axis) direction.

The guide frame 500 may be a rectangular frame having an opening in the optical axis (Z-axis) direction. In an embodiment, the planar shape of the guide frame 500 may be approximately a ‘u’ shape.

The carrier 400 and the guide frame 500 may be disposed in front of the reflective member 300. That is, the carrier 400 and the guide frame 500 may be disposed to be higher than the reflective member 300 in the optical axis (Z-axis) direction.

The lens module 200 may be accommodated in the housing 100. For example, the lens module 200 may be disposed inside the opening 130 formed in the one surface of the housing 100. In an embodiment, the carrier 400 may be disposed inside the housing 100, and the lens module 200 may be accommodated inside the carrier 400.

The camera module 3 may adjust a focus by moving the lens module 200 in the optical axis (Z-axis) direction, and may stabilize an optical image at the time of capturing the image by moving the lens module 200 in a direction perpendicular to the optical axis (Z-axis).

The camera module 3 may further include a focus adjustment unit 600 moving the lens module 200 in the optical axis (Z-axis) direction, and an optical image stabilization unit 700 moving the lens module 200 in a direction perpendicular to the optical axis (Z-axis) direction.

The camera module 3 may further include an image sensor module 800 and a case 110.

Referring to FIGS. 10 and 11, the image sensor module 800 may include an image sensor 810 and a printed circuit board 830 connected to the image sensor 810, and may further include a sensor housing 850.

The image sensor 810 may convert light incident through the lens module 200 into an electric signal. As an example, the image sensor 810 may be a charge-coupled device (CCD) or a complementary metal-oxide-semiconductor (CMOS) device.

The electric signal converted by the image sensor 810 may be output as an image through a display unit of a portable electronic device in which the camera module 3 is mounted.

The image sensor 810 may be fixed to the printed circuit board 830, and may be electrically connected to the printed circuit board 830 by wire bonding.

The image sensor 810 may have an imaging surface on which light is received, and the imaging surface of the image sensor 810 may be a surface intersecting the optical axis (Z-axis) direction. The image sensor 810 may be disposed to be spaced apart from the reflective member 300. For example, the image sensor 810 may be spaced apart from the reflective member 300 upward in the optical axis (Z-axis) direction.

In an embodiment, both the lens module 200 and the image sensor 810 may be disposed to be higher than the reflective member 300 in the optical axis (Z-axis) direction. For example, the lens module 200 and the image sensor 810 may be disposed closer to an object than the reflective member 300 is. That is, among the lens module 200, the image sensor 810, and the reflective member 300, the lens module 200 and the image sensor 810 may be the closest ones to the object, and the reflective member 300 may be the farthest one from the object.

The image sensor module 800 may be mounted in the housing 100. As an example, the image sensor module 800 may be disposed in the opening 130 formed in the one surface of the housing 100.

In an embodiment, the sensor housing 850 may be coupled to the printed circuit board 830, and the image sensor 810 may be disposed in an internal space of the sensor housing 850. In addition, either one or both of the sensor housing 850 and the printed circuit board 830 may be coupled to the housing 100.

The lens module 200 and the image sensor 810 may be disposed in the opening 130 of the housing 100, and may be disposed to be spaced apart from each other in a direction (e.g., the first axis (X-axis) direction) intersecting the optical axis (Z-axis) direction.

The case 110 may be coupled to the housing 100 to cover an outer surface of the housing 100, and may function to protect the internal components of the camera module 3.

The reflective member 300 may have one surface facing in the optical axis (Z-axis) direction. The one surface of the reflective member 300 may be a surface intersecting the optical axis (Z-axis) direction. As an example, the one surface of the reflective member 300 may be an upper surface of the reflective member 300 as shown in FIG. 17.

The lens module 200 and the image sensor 810 may be disposed closer to an object than the reflective member 300 is, and may be spaced apart from each other in a direction intersecting the optical axis (Z-axis) direction. That is, among the lens module 200, the image sensor 810, and the reflective member 300, the lens module 200 and the image sensor 810 may be the closest ones to the object, and the reflective member 300 may be the farthest one from the object.

In an embodiment, the lens module 200 may face a partial portion of the one surface (e.g., the upper surface) of the reflective member 300, and the image sensor 810 may face another partial portion of the one surface (e.g., the upper surface) of the reflective member 300.

The reflective member 300 may have one or more reflection surfaces. Since light having passed through the lens module 200 enters the image sensor 810 after being reflected by the reflective member 300, a long optical path can be formed within a limited space.

In addition, since the lens module 200 is disposed in front of the reflective member 300, the Fno (the F-number of the camera module 3) can be reduced to capture a bright image.

Referring to FIG. 12, in an embodiment, the reflective member 300 may be in the form of a trapezoidal prism. The reflective member 300 may include an incident surface 310 on which light is incident, a first reflection surface 320 reflecting light having passed through the incident surface 310, a second reflection surface 330 reflecting light reflected from the first reflection surface 320, a third reflection surface 340 reflecting light reflected from the second reflection surface 330, and an emission surface 350 from which light reflected from the third reflection surface 340 is emitted. Light having passed through the emission surface 350 may be incident on the image sensor 810.

The image sensor 810 being disposed closer to the object than the reflective member 300 is may mean that the image sensor 810 is disposed closer to the object than the emission surface 350 of the reflective member 300 is.

The incident surface 310, the second reflection surface 330, and the emission surface 350 may be one surface extending on the same plane.

Each of the first reflection surface 320 and the third reflection surface 340 may be inclined with respect to the second reflection surface 330.

A partial portion of the reflective member 300 may be disposed in the internal space of the carrier 400. In an embodiment, the incident surface 310 and the first reflection surface 320 of the reflective member 300 may be disposed in the internal space of the carrier 400. FIG. 23 is a schematic cross-sectional view of the camera module of FIG. 16.

Referring to FIG. 23, at least a partial portion 120 of a bottom surface of the housing 100 facing the image sensor 810 in the optical axis (Z-axis) direction may be inclined with respect to the optical axis (Z-axis) direction. That is, at least a partial portion 120 of the bottom surface of the housing 100 may be an inclined surface.

At least a partial portion of the third reflection surface 340 may be located between the inclined surface of the housing 100 and the image sensor 810. The third reflection surface 340 and the inclined surface of the housing 100 may be parallel to each other. For example, an inclination angle of the third reflection surface 340 with respect to the optical axis (Z-axis) direction and an inclination angle of the inclined surface of the housing 100 with respect to the optical axis (Z-axis) direction may be the same.

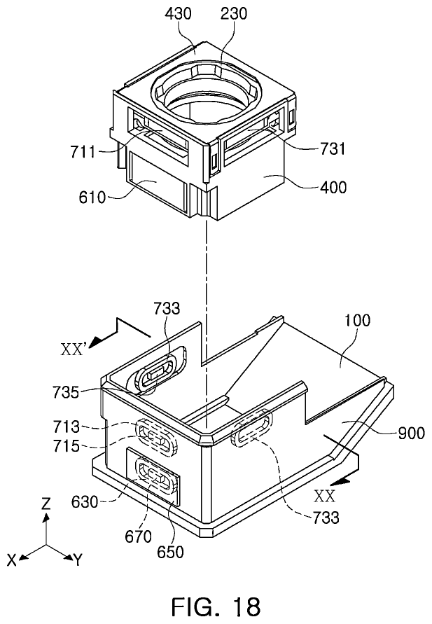

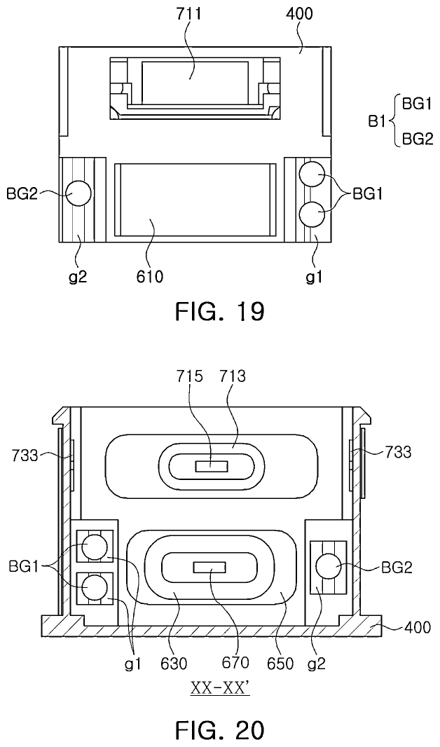

FIG. 18 is a partial exploded perspective view of the camera module of FIGS. 16 and 17, FIG. 19 is a side view of a carrier of FIGS. 17 and 18, and FIG. 20 is a cross-sectional view of a housing of FIGS. 16 and 17 taken along the line XX-XX′ in FIG. 18.

The camera module 3 may move the lens module 200 to focus on a subject. To this end, the camera module 3 may include a focus adjustment unit 600.

The focus adjustment unit 600 may move the carrier 400 by generating a driving force in the optical axis (Z-axis) direction. Since the lens module 200 is disposed on the carrier 400, the carrier 400 and the lens module 200 may be moved together in the optical axis (Z-axis) direction by the driving force generated by the focus adjustment unit 600. In addition, since the guide frame 500 is disposed on the carrier 400, the guide frame 500 may be moved together with the carrier 400 in the optical axis (Z-axis) direction.

The focus adjustment unit 600 may include a first magnet 610 and a first coil 630. The first magnet 610 and the first coil 630 may be disposed to face each other in a direction perpendicular to the optical axis (Z-axis).

The first magnet 610 may be mounted on the carrier 400. As an example, the first magnet 610 may be mounted on one side surface of the carrier 400. A back yoke (not shown) may be disposed between one side surface of the carrier 400 and the first magnet 610. The back yoke may be made of a magnetic material. The back yoke makes it possible to prevent a magnetic field of the first magnet 610 from leaking into the carrier 400.

One surface (e.g., a surface facing the first coil 630) of the first magnet 610 may be magnetized to have both an N pole and an S pole. As an example, an N pole, a neutral region, and an S pole may be sequentially provided along the optical axis (Z-axis) direction on the one surface of the first magnet 610 facing the first coil 630.

The first coil 630 may be disposed to face the first magnet 610. For example, the first coil 630 may be disposed to face the first magnet 610 in a direction perpendicular to the optical axis (Z-axis).

The first coil 630 may be disposed on a substrate 900, and the substrate 900 may be mounted on the housing 100 in such a manner that the first magnet 610 and the first coil 630 face each other in a direction perpendicular to the optical axis (Z-axis). As an example, the first coil 630 may be disposed on one surface of the substrate 900. The substrate 900 may be mounted on a side surface of the housing 100 in such a manner that the first magnet 610 and the first coil 630 face each other in a direction perpendicular to the optical axis (Z-axis).

The housing 100 may have a through-hole penetrating the housing 100, and the first coil 630 disposed on the substrate 900 may directly face the first magnet 610 through the through-hole.

At the time of adjusting a focus, the first magnet 610 may be a movable member mounted on the carrier 400 and moving in the optical axis (Z-axis) direction together with the carrier 400, and the first coil 630 may be a fixed member fixed to the substrate 900.

When power is applied to the first coil 630, the carrier 400 may be moved in the optical axis (Z-axis) direction by an electromagnetic force generated between the first magnet 610 and the first coil 630.

Since the lens module 200 is disposed on the carrier 400, the lens module 200 may also be moved in the optical axis (Z-axis) direction by the movement of the carrier 400.

A first ball member B1 may be disposed between the carrier 400 and the housing 100. For example, the first ball member B1 may be disposed between the carrier 400 and the housing 100 to reduce friction when the carrier 400 is moved.

The first ball member B1 may include a plurality of balls arranged along the optical axis (Z-axis) direction. The plurality of balls may be moved in a rolling manner in the optical axis (Z-axis) direction when the carrier 400 is moved in the optical axis (Z-axis) direction.

The first ball member B1 may include a first ball group BG1 and a second ball group BG2, and each of the first ball group BG1 and the second ball group BG2 may include one or more balls. The first ball group BG1 and the second ball group BG2 may be disposed to be spaced apart from each other in a direction perpendicular to the optical axis (Z-axis).

A first yoke 650 may be disposed on the housing 100. The first yoke 650 may be disposed at a position facing the first magnet 610. For example, the first coil 630 may be disposed on one surface of the substrate 900, and the first yoke 650 may be disposed on the other surface of the substrate 900.

The first magnet 610 and the first yoke 650 may generate an attractive force therebetween. For example, the first yoke 650 may be made of a magnetic material. The attractive force may act in a direction perpendicular to the optical axis (Z-axis) between the first magnet 610 and the first yoke 650.

The first ball member B1 may be in contact with each of the carrier 400 and the housing 100 due to the attractive force generated between the first magnet 610 and the first yoke 650.

Guides grooves may be formed in each of the surfaces of the carrier 400 and the housing 100 facing each other. For example, a first guide groove g1 accommodating the first ball group BG1 and a second guide groove g2 accommodating the second ball group BG2 may be formed in each of the surfaces of the carrier 400 and the housing 100 facing each other.

Each of the first guide groove g1 and the second guide groove g2 may extend in the optical axis (Z-axis) direction.

The first ball group BG1 and the second ball group BG2 may be disposed to be spaced apart from each other in the second axis (Y-axis) direction. The number of balls in the first ball group BG1 and the number of balls in the second ball group BG2 may be different. Specifically, the number of balls included in the first ball group BG1 may be greater than the number of balls included in the second ball group BG2.

For example, the first ball group BG1 may include two or more balls disposed along the optical axis (Z-axis) direction, and the second ball group BG2 may include a smaller number of balls than the number of balls included in the first ball group BG1.

On the premise that the number of balls belonging to the first ball group BG1 and the number of balls belonging to the second ball group BG2 are different, the number of balls belonging to each ball group may be changed. Hereinafter, for convenience of explanation, the description will be made based on an embodiment in which the first ball group BG1 includes two balls and the second ball group BG2 includes one ball.

Each of the two balls in the first ball group BG1 may be in contact with the carrier 400 at two points and in contact with the housing 100 at two points.

The one ball in the second ball group BG2 may be in contact with the carrier 400 at one point and in contact with the housing 100 at two points (or vice versa).

The first ball group BG1 and the first guide groove g1 may function as a main guide that guides a movement of the carrier 400 in the optical axis (Z-axis) direction, and the second ball group BG2 and the second guide groove g2 may function as an auxiliary guide that supports a movement of the carrier 400 in the optical axis (Z-axis) direction.

A length of the first guide groove g1 of the carrier 400 in the optical axis (Z-axis) direction may be longer than a height of the reflective member 300 in the optical axis (Z-axis) direction.

Either one or both of the first ball group BG1 and the second ball group BG2 may be disposed to overlap the reflective member 300 in a direction perpendicular to the optical axis (Z-axis) direction. For example, each of the first ball group BG1 and the second ball group BG2 may be disposed to at least partially overlap the reflective member 300 in the first axis (X-axis) direction.

In an embodiment, an auxiliary yoke (not shown) may be disposed at a position facing the first magnet 610. For example, the auxiliary yoke may be disposed on the substrate 900 to face the first magnet 610. In addition, the auxiliary yoke may be disposed on an inner side of the first coil 630.

The auxiliary yoke may be located closer to the first ball group BG1 than to the second ball group BG2. The auxiliary yoke may be made of a material capable of generating an attractive force with the first magnet 610.

Accordingly, a central point of a resultant force of the attractive force generated between the first magnet 610 and the first yoke 650 and the attractive force generated between the first magnet 610 and the auxiliary yoke may be located closer to the first ball group BG1 than to the second ball group BG2.

In an embodiment, the camera module 3 may detect a position of the carrier 400 in the optical axis (Z-axis) direction.

To this end, a first position sensor 670 may be provided. The first position sensor 670 may be disposed on the substrate 900 to face the first magnet 610. The first position sensor 670 may be a Hall sensor.

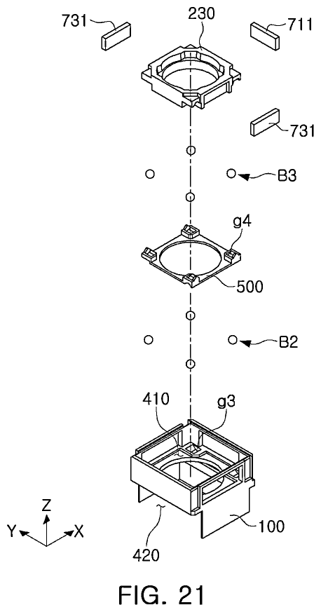

FIG. 21 is an exploded perspective view illustrating a carrier, a guide frame, and a holder of FIG. 17.

The camera module 3 may stabilize an optical image at the time of capturing the image by moving the lens module 200 in a direction perpendicular to the optical axis (Z-axis). To this end, the camera module 3 may include an optical image stabilization unit 700 moving the lens module 200 in a direction perpendicular to the optical axis (Z-axis).

The guide frame 500 and the lens module 200 may be sequentially accommodated in the carrier 400. For example, the guide frame 500 may be disposed between the carrier 400 and the lens module 200.

In an embodiment, the carrier 400 may have a first internal space 410 and a second internal space 420. The first internal space 410 and the second internal space 420 may be disposed to be spaced apart from each other in the optical axis (Z-axis) direction. The carrier 400 may have a bottom surface that separates the first internal space 410 and the second internal space 420 from each other. The bottom surface may have a through-hole through which light passes.

The guide frame 500 and the lens module 200 may be disposed in the first internal space 410 of the carrier 400, and a partial portion of the reflective member 300 may be disposed in the second internal space 420 of the carrier 400.

The guide frame 500 and the lens module 200 may be moved together in one direction perpendicular to the optical axis (Z-axis) by a driving force generated by the optical image stabilization unit 700, and the lens module 200 may be moved relative to the guide frame 500 in the other direction perpendicular to the optical axis (Z-axis) by an driving force generate by the optical image stabilization unit 700.

For example, the guide frame 500 and the lens module 200 may be moved together in the first axis (X-axis) direction perpendicular to the optical axis (Z-axis), and the lens module 200 may be moved relative to the guide frame 500 in the second axis (Y-axis) direction perpendicular to both the optical axis (Z-axis) and the first axis (X-axis).

The optical image stabilization unit 700 may include a first sub-stabilization unit 710 and a second sub-stabilization unit 730. The first sub-stabilization unit 710 may generate a driving force in the first axis (X-axis) direction, and the second sub-stabilization unit 730 may generate driving force in the second axis (Y-axis) direction. The first sub-stabilization unit 710 and the second sub-stabilization unit 730 may be disposed to be spaced apart from the reflective member 300 upward in the optical axis (Z-axis) direction. That is, the optical image stabilization unit 700 may be disposed to be higher than the reflective member 300 in the optical axis (Z-axis) direction.

The first sub-stabilization unit 710 may include a second magnet 711 and a second coil 713. The second magnet 711 and the second coil 713 may be disposed to face each other in the first axis (X-axis) direction.

The second magnet 711 may be disposed on the lens module 200. For example, the second magnet 711 may be mounted on one side surface of the holder 230.

One surface (e.g., a surface facing the second coil 713) of the second magnet 711 may be magnetized to have an N pole or an S pole. The second magnet 711 may have a length extending in the second axis (Y-axis) direction.

The other surface of the second magnet 711 may be magnetized to have a polarity opposite to the polarity of the one surface of the second magnet 711.

The second coil 713 may be disposed to face the second magnet 711. For example, the second coil 713 may be disposed to face the second magnet 711 in the first axis (X-axis) direction.

The second coil 713 may be disposed on the substrate 900, and the substrate 900 may be mounted on the housing 100 in such a manner that the second magnet 711 and the second coil 713 face each other in the first axis (X-axis) direction.

The housing 100 may have a through-hole, and the second coil 713 disposed on the substrate 900 may directly face the second magnet 711 through the through-hole.

The through-hole where the first coil 630 is disposed and the through-hole where the second coil 713 is disposed may be disposed to be spaced apart in the optical axis (Z-axis) direction.

The first magnet 610 of the focus adjustment unit 600 and the second magnet 711 of the optical image stabilization unit 700 may be disposed to be spaced apart from each other in the optical axis (Z-axis) direction. In addition, the first coil 630 and the second coil 713 may also be disposed to be spaced apart from each other in the optical axis (Z-axis) direction.

At the time of stabilizing an optical image, the second magnet 711 may be a movable member mounted on the lens module 200, and the second coil 713 may be a fixed member fixed to the housing 100.

When power is applied to the second coil 713, the lens module 200 and the guide frame 500 may be moved in the first axis (X-axis) direction by an electromagnetic force generated between the second magnet 711 and the second coil 713.

The second magnet 711 and the second coil 713 may generate a driving force in a direction in which they face each other (e.g., the first axis (X-axis) direction).

The second sub-stabilization unit 730 may include a third magnet 731 and a third coil 733. The third magnet 731 and the third coil 733 may be disposed to face each other in the second axis (Y-axis) direction.

The third magnet 731 may be disposed on the lens module 200. For example, the third magnet 731 may be mounted on another side surface of the holder 230.

One surface (e.g., a surface facing the third coil 733) of the third magnet 731 may be magnetized to have an S pole or an N pole. The third magnet 731 may have a length extending in the first axis (X-axis) direction.

The other surface of the third magnet 731 may be magnetized to have a polarity opposite to the polarity of the one surface of the third magnet 731.

The third coil 733 may be disposed to face the third magnet 731. For example, the third coil 733 may be disposed to face the third magnet 731 in the second axis (Y-axis) direction.

The third coil 733 may be disposed on the substrate 900, and the substrate 900 may be mounted on the housing 100 in such a manner that the third magnet 731 and the third coil 733 face each other in the second axis (Y-axis) direction.

The housing 100 may have a through-hole, and the third coil 733 disposed on the substrate 900 may directly face the third magnet 731 through the through-hole.

At the time of stabilizing an optical image, the third magnet 731 may be a movable member mounted on the lens module 200, and the third coil 733 may be a fixed member fixed to the housing 100.

When power is applied to the third coil 733, the lens module 200 may be moved in the second axis (Y-axis) direction by an electromagnetic force generated between the third magnet 731 and the third coil 733.

The third magnet 731 and the third coil 733 may generate a driving force in a direction in which they face each other (e.g., the second axis (Y-axis) direction).

The second magnet 711 and the third magnet 731 may be disposed perpendicular to each other on a plane perpendicular to the optical axis (Z-axis), and the second coil 713 and the third coil 733 may also be disposed perpendicular to each other on the plane perpendicular to the optical axis (Z-axis).

In an embodiment, the third magnet 731 may include two magnets disposed to be spaced apart from each other in the second axis (Y-axis) direction, and the third coil 733 may include two coils disposed to be spaced apart from each other in the second axis (Y-axis) direction. However, the third magnet 731 and the third coil 733 are not limited thereto, and the third magnet 731 may be formed as one magnet and the third coil 733 may be formed as one coil.

The camera module 3 according to another embodiment of the present disclosure may include a plurality of ball members supporting the guide frame 500 and the lens module 200. The plurality of ball members may function to guide movements of the guide frame 500 and the lens module 200 during an optical image stabilizing process. The plurality of ball members may also function to maintain gaps between the carrier 400, the guide frame 500, and the lens module 200.

The plurality of ball members may include a second ball member B2 and a third ball member B3. The second ball member B2 may be disposed between the carrier 400 and the guide frame 500, and the third ball member B3 may be disposed between the guide frame 500 and the lens module 200.

The second ball member B2 may guide movements of the guide frame 500 and the lens module 200 in the first axis (X-axis) direction, and the third ball member B3 may guide a movement of the lens module 200 in the second axis (Y-axis) direction.

As an example, the second ball member B2 may move in a rolling manner in the first axis (X-axis) direction when a driving force is generated in the first axis (X-axis) direction. Accordingly, the second ball member B2 may guide movements of the guide frame 500 and the lens module 200 in the first axis (X-axis) direction.

The third ball member B3 may move in a rolling manner in the second axis (Y-axis) direction when a driving force is generated in the second axis (Y-axis) direction. Accordingly, the third ball member B3 may guide a movement of the lens module 200 in the second axis (Y-axis) direction.

The second ball member B2 may include a plurality of balls disposed between the carrier 400 and the guide frame 500, and the third ball member B3 may include a plurality of balls disposed between the guide frame 500 and the lens module 200.

For example, each of the second ball member B2 and the third ball member B3 may include four balls.

A third guide groove g3 accommodating the second ball member B2 may be formed either one or both of the surfaces of the carrier 400 and the guide frame 500 facing each other in the optical axis (Z-axis) direction. The third guide groove g3 may include a plurality of grooves corresponding to the plurality of balls of the second ball member B2.

The second ball member B2 may be accommodated in the third guide groove g3, and inserted between the carrier 400 and the guide frame 500.

In a state in which the second ball member B2 is accommodated in the third guide groove g3, the second ball member B2 may be moved only in the first axis (X-axis) direction, while its movements in the optical axis (Z-axis) direction and in the second axis (Y-axis) direction are restricted. As an example, the second ball member B2 may move in a rolling manner only in the first axis (X-axis) direction.

To this end, the planar shape of each of the plurality of grooves of the third guide groove g3 may be a rectangle having a length extending in the first axis (X-axis) direction.

A fourth guide groove g4 accommodating the third ball member B3 may be formed in either one or both of the surfaces of the guide frame 500 and the lens module 200 (e.g., the holder 230) facing each other in the optical axis (Z-axis) direction. The fourth guide groove g4 may include a plurality of grooves corresponding to the plurality of balls of the third ball member B3.

The third ball member B3 may be accommodated in the fourth guide groove g4, and inserted between the guide frame 500 and the lens module 200.

In a state in which the third ball member B3 is accommodated in the fourth guide groove g4, the third ball member B3 may be moved only in the second axis (Y-axis) direction, while its movements in the optical axis (Z-axis) direction and in the first axis (X-axis) direction are restricted. As an example, the third ball member B3 may move in a rolling manner only in the second axis (Y-axis) direction.

To this end, the planar shape of each of the plurality of grooves of the fourth guide groove g4 may be a rectangle having a length extending in the second axis (Y-axis) direction.

When a driving force is generated in the first axis (X-axis) direction, the guide frame 500 and the lens module 200 may move together in the first axis (X-axis) direction. Here, the second ball member B2 may move in a rolling manner along the first axis (X-axis). At this time, a movement of the third ball member B3 may be restricted.

When a driving force is generated in the second axis (Y-axis) direction, the lens module 200 may be moved relative to the guide frame 500 in the second axis (Y-axis) direction. Here, the third ball member B3 may move in a rolling manner along the second axis (Y-axis). At this time, a movement of the second ball member B2 may be restricted.

In an embodiment, the camera module 3 may detect a position of the lens module 200 in a direction perpendicular to the optical axis (Z-axis).

To this end, a second position sensor 715 and a third position sensor 735 may be provided. The second position sensor 715 may be disposed on the substrate 900 to face the second magnet 711, and the third position sensor 735 may be disposed on the substrate 900 to face the third magnet 731. The second position sensor 715 and the third position sensor 735 may be Hall sensors.

In the present disclosure, a second yoke (not shown) and a third yoke (not shown) may be provided to keep the carrier 400 and the guide frame 500 in contact with the second ball member B2, and keep the guide frame 500 and the lens module 200 in contact with the third ball member B3.

The second yoke and the third yoke may be fixed to the carrier 400, and may be disposed to face the second magnet 711 and the third magnet 731 in the optical axis (Z-axis) direction. For example, the second yoke and third yoke may be disposed on a bottom surface of the carrier 400.

Therefore, attractive forces may be generated in the optical axis (Z-axis) direction between the second yoke and the second magnet 711 and between the third yoke and the third magnet 731.

Due to the attractive force generated between the second yoke and the second magnet 711 and the attractive force generated between the third yoke and the third magnet 731, the lens module 200 and the guide frame 500 may be pressed in a direction toward the second yoke and the third yoke, making it possible to keep the guide frame 500 and the lens module 200 in contact with the second ball member B2 and the third ball member B3.

The second yoke and the third yoke may be made of a material capable of generating an attractive force with the second magnet 711 and the third magnet 731. As an example, the second yoke and the third yoke may be made of a magnetic material.

Referring to FIG. 17, a stopper 430 may be coupled to the carrier 400. The stopper 430 may be coupled to the carrier 400 to cover at least a partial portion of an upper surface of the lens module 200. For example, the stopper 430 may cover at least a partial portion of the upper surface of the holder 230.

The stopper 430 may prevent the guide frame 500 and the lens module 200 from separating from the carrier 400 due to an external shock or other disturbance.

A buffer member (not shown) having an elastic property may be coupled to an edge portion of the stopper 430.

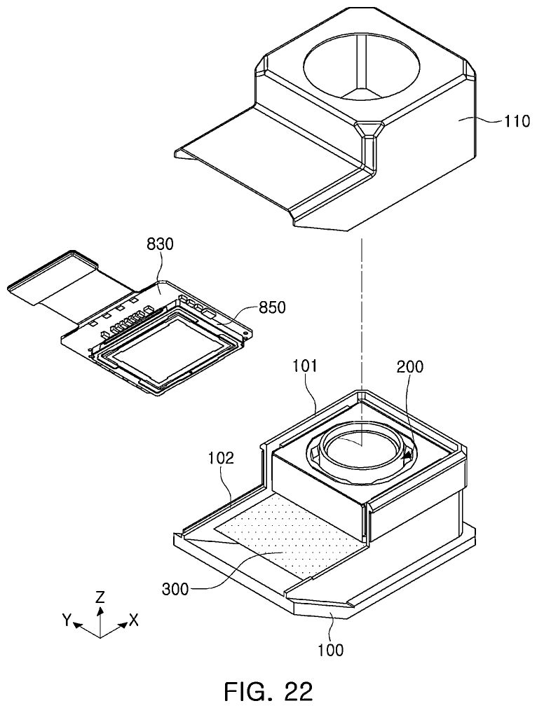

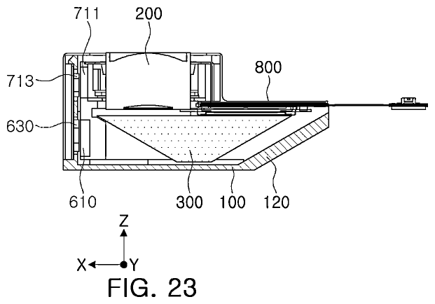

FIG. 22 is a perspective view illustrating a state in which a case and an image sensor module are separated from the camera module of FIG. 16 and the image sensor module is illustrated in a bottom perspective view. FIG. 23 is a schematic cross-sectional view of the camera module of FIG. 16.

Referring to FIGS. 22 and 23, the upper surface of the housing 100 may have a step. In an embodiment, the housing 100 may include a first upper surface 101 and a second upper surface 102. The first upper surface 101 may be disposed at a higher position than the second upper surface 102 in the positive optical axis (Z-axis) direction.

The lens module 200 may be disposed within an area defined by the first upper surface 101. In addition, a partial portion of the image sensor module 800 may be disposed within the area defined by the first upper surface 101. The other portion of the image sensor module 800 may be disposed within an area defined by the second upper surface 102.

Each of the area defined by the first upper surface 101 and the area defined by the second upper surface 102 may be parts of an internal space of the housing 100.

Since a partial portion of the image sensor module 800 is located within the area defined by the first upper surface 101, the length of the reflective member 300 in the first axis (X-axis) direction can be reduced.

In an embodiment, a partial portion of the image sensor 810 may be disposed in the second internal space 420 of the carrier 400.

In an embodiment, at least a partial portion of the focus adjustment unit 600 may be disposed to overlap the reflective member 300 in a direction perpendicular to the optical axis (Z-axis).

For example, a partial portion of the first magnet 610 and a partial portion of the first coil 630 may be disposed to overlap the reflective member 300 in a direction in which the first magnet 610 and the first coil 630 face each other.

At least a partial portion of the first magnet 610 may be disposed to be spaced apart from the first reflection surface 320 of the reflective member 300 in the first axis (X-axis) direction. In addition, at least a partial portion of the first coil 630 may be disposed to be spaced apart from the first reflection surface 320 of the reflective member 300 in the first axis (X-axis) direction.

The optical image stabilization unit 700 may be disposed to be higher than the reflective member 300 in the optical axis (Z-axis) direction.

Since at least a partial portion of the focus adjustment unit 600 is disposed to overlap the reflective member 300 in a direction perpendicular to the optical axis (Z-axis), and the optical image stabilization unit 700 is disposed to be higher than the reflective member 300 in the optical axis (Z-axis) direction, the size (e.g., the length in the direction perpendicular to the optical axis (Z-axis)) of the camera module 3 can be reduced.

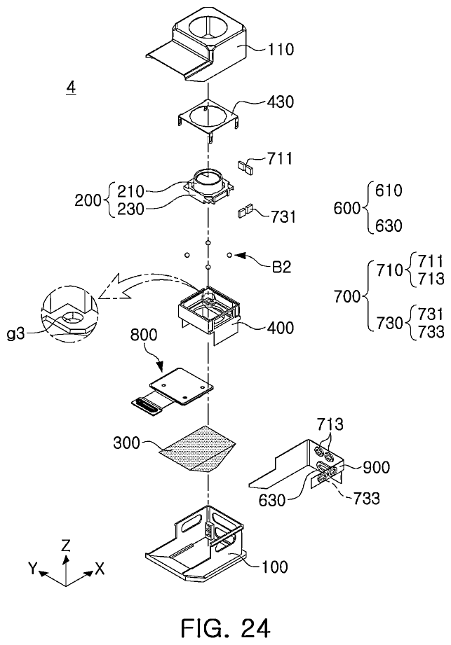

FIG. 24 is an exploded perspective view of a camera module according to another embodiment of the present disclosure.

When compared to the camera module 3 described with reference to FIGS. 16 to 23, a camera module 4 of FIG. 24 differs in whether the guide frame 500 is present and the configuration of the optical image stabilization unit 700.

For example, in the camera module 4 of FIG. 24, the guide frame 500 is not disposed between the carrier 400 and the lens module 200. In addition, since the guide frame 500 is not disposed, the third ball member B3 disposed between the guide frame 500 and the lens module 200 is also not provided.

Since the configuration of the optical image stabilization unit 700 for the camera module 4 of FIG. 24 is similar to that for the camera module 2 described with reference to FIG. 15, a detailed description thereof will be omitted.

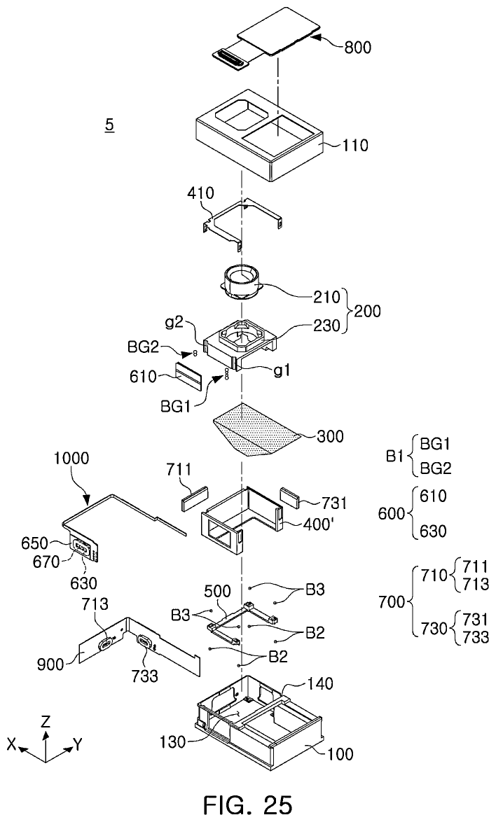

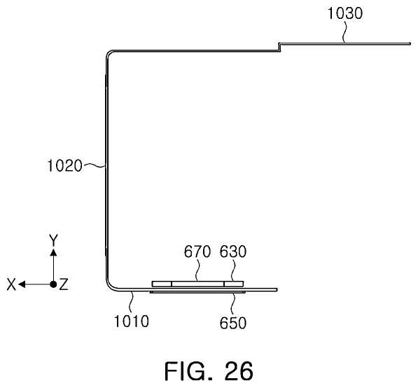

FIG. 25 is an exploded perspective view of a camera module according to another embodiment of the present disclosure, and FIG. 26 is a plan view of a connection substrate of the camera module of FIG. 25.

Referring to FIG. 25, a camera module 5 according to another embodiment of the present disclosure may include a lens module 200, a reflective member 300, and a housing 100.

The lens module 200 may include a lens barrel 210 and a holder 230. The lens barrel 210 may have a hollow cylindrical shape, and at least one lens for imaging a subject may be accommodated inside the lens barrel 210. In a case in which a plurality of lenses are arranged, the plurality of lenses may be mounted inside the lens barrel 210 along the optical axis (Z-axis).

The lens barrel 210 may be moved in one or more of three axial directions intersecting each other.

The lens barrel 210 may be coupled to the holder 230. The lens barrel 210 and the holder 230 may be moved together.

The housing 100 may have an internal space. In an embodiment, the housing 100 may be shaped like a rectangular box. An opening 130 may be formed in one surface of the housing 100. The internal space of the housing 100 may be exposed to the outside of the housing 100 through the opening 130. The one surface of the housing 100 may be an upper surface of the housing 100 in FIG. 25.

The reflective member 300 may disposed in the internal space of the housing 100. In addition, the lens barrel 210 of the lens module 200 may be disposed in front of the reflective member 300. Here, the expression “in front of” may refer to a positive optical axis (Z-axis) direction (+Z-axis direction) with respect to the reflective member 300. For example, the lens barrel 210 may be spaced apart from the reflective member 300 upward in the optical axis (Z-axis) direction.

Therefore, light may be incident on the reflective member 300 after passing through the lens barrel 210.

The lens module 200 may be moved in one or more of the three axial directions intersecting each other. In addition, the lens module 200 may be moved relative to the reflective member 300.

For example, the lens module 200 may be moved in the optical axis (Z-axis) direction for focus adjustment. In addition, the lens module 200 may be moved in a direction perpendicular to the optical axis (Z-axis) for optical image stabilization.

In an embodiment, the three axial directions intersecting each other may be the optical axis (Z-axis) direction, the first axis (X-axis) direction, and the second axis (Y-axis) direction.

The camera module 5 may further include a carrier 400′ and a guide frame 500.

The carrier 400′ and the guide frame 500 may be disposed inside the housing 100, each being movable relative to the housing 100 in a direction perpendicular to the optical axis (Z-axis) direction. Since the reflective member 300 is fixed to the housing 100, the carrier 400′ and the guide frame 500 may also be moved relative to the reflective member 300.

The carrier 400′ and the guide frame 500 may be disposed in the internal space of the housing 100, and the lens module 200 may be accommodated in the carrier 400′.

The guide frame 500 may be disposed in the internal space of the housing 100, and the carrier 400′ may be disposed on the guide frame 500.

The carrier 400′ and the lens module 200 may be moved together in a direction perpendicular to the optical axis (Z-axis) direction. Accordingly, the camera module 5 may stabilize an optical image at the time of capturing the image.

In addition, the lens module 200 may be disposed inside the carrier 400′ in the optical axis (Z-axis) direction. Accordingly, the camera module 5 may adjust a focus.

The guide frame 500 may be a rectangular frame having an opening in the optical axis (Z-axis) direction, with one side being open. In an embodiment, the planar shape of the guide frame 500 may be approximately a ‘⊏’ shape. At least a partial portion of the reflective member 300 may be located on one side of the guide frame 500 that is open. As a result, the guide frame 500 and the reflective member 300 can be prevented from interfering with each other.

In another embodiment, the guide frame 500 may be a rectangular frame with two sides being open. In this case, the planar shape of the guide frame 500 may be approximately a ‘¬’ shape.

The camera module 5 may further include an image sensor module 800 and a case 110.

Referring to FIGS. 10 and 11, the image sensor module 800 may include an image sensor 810 and a printed circuit board 830 connected to the image sensor 810, and may further include a sensor housing 850.

The image sensor 810 may convert light incident through the lens module 200 into an electric signal. As an example, the image sensor 810 may be a charge-coupled device (CCD) or a complementary metal-oxide-semiconductor (CMOS) device.

The electric signal converted by the image sensor 810 may be output as an image through a display unit of a portable electronic device in which the camera module 5 is mounted.

The image sensor 810 may be fixed to the printed circuit board 830, and may be electrically connected to the printed circuit board 830 by wire bonding.

The image sensor 810 may have an imaging surface on which light is received, and the imaging surface of the image sensor 810 may be a surface intersecting the optical axis (Z-axis) direction. The image sensor 810 may be disposed to be spaced apart from the reflective member 300. For example, the image sensor 810 may be spaced apart from the reflective member 300 upward in the optical axis (Z-axis) direction.

In an embodiment, both the lens barrel 210 and the image sensor 810 may be disposed to be higher than the reflective member 300 in the optical axis (Z-axis) direction. For example, the lens barrel 210 and the image sensor 810 may be disposed closer to an object than the reflective member 300 is.

The image sensor module 800 may be mounted in the housing 100. As an example, the image sensor module 800 may be disposed in the opening 130 formed in the one surface of the housing 100.

In an embodiment, the sensor housing 850 may be coupled to the printed circuit board 830, and the image sensor 810 may be disposed in an internal space of the sensor housing 850. In addition, either one or both of the sensor housing 850 and the printed circuit board 830 may be coupled to the housing 100.

The lens barrel 210 of the lens module 200 and the image sensor 810 of the image sensor module 800 may be disposed in the opening 130 of the housing 100, and may be disposed to be spaced apart from each other in a direction (e.g., the first axis (X-axis) direction) intersecting the optical axis (Z-axis) direction.

The case 110 may be coupled to the housing 100 to cover an outer surface of the housing 100, and may function to protect the components inside the camera module 1.

The reflective member 300 may have one surface facing the optical axis (Z-axis) direction. The one surface of the reflective member 300 may be a surface intersecting the optical axis (Z-axis) direction. As an example, the one surface of the reflective member 300 may be an upper surface of the reflective member 300 in FIG. 25.

The lens barrel 210 and the image sensor 810 may be disposed closer to an object than the reflective member 300 is, and may be spaced apart from each other in a direction intersecting the optical axis (Z-axis) direction. That is, among the lens barrel 210, the image sensor 810, and the reflective member 300, the lens barrel 210 and the image sensor 810 may be the closest ones to the object, and the reflective member 300 may be the farthest one from the object.

In an embodiment, the lens barrel 210 may face a partial portion of the one surface (e.g., the upper surface) of the reflective member 300, and the image sensor 810 may face another partial portion of the one surface (e.g., the upper surface) of the reflective member 300.

The reflective member 300 may have one or more reflection surfaces. Since light having passed through the lens module 200 enters the image sensor 810 after being reflected by the reflective member 300, a long optical path can be formed within a limited space.

In addition, since the lens barrel 210 is disposed in front of the reflective member 300, the Fno (the F-number of the camera module 5) can be reduced to capture a bright image.

Referring to FIG. 12, in an embodiment, the reflective member 300 may be in the form of a trapezoidal prism. The reflective member 300 may include an incident surface 310 on which light is incident, a first reflection surface 320 reflecting light having passed through the incident surface 310, a second reflection surface 330 reflecting light reflected from the first reflection surface 320, a third reflection surface 340 reflecting light reflected from the second reflection surface 330, and an emission surface 350 from which light reflected from the third reflection surface 340 is emitted. Light having passed through the emission surface 350 may be incident on the image sensor 810.

The image sensor 810 being disposed closer to the object than the reflective member 300 is may mean that the image sensor 810 is disposed closer to the object than the emission surface 350 of the reflective member 300 is.

In an embodiment, the incident surface 310, the second reflection surface 330, and the emission surface 350 may be one surface extending on the same plane. For example, the incident surface 310, the second reflection surface 330, and the emission surface 350 may be portions of one surface of the reflective member 300.

Each of the first reflection surface 320 and the third reflection surface 340 may be inclined with respect to the second reflection surface 330.

A partial portion of the reflective member 300 may be disposed in the internal space of the carrier 400′. In an embodiment, the incident surface 310 and the first reflection surface 320 of the reflective member 300 may be disposed in the internal space of the carrier 400′.

The camera module 5 may further include a focus adjustment unit 600 moving the lens module 200 in the optical axis (Z-axis) direction, and an optical image stabilization unit 700 moving the lens module 200 in a direction perpendicular to the optical axis (Z-axis) direction.

The focus adjustment unit 600 may move the lens module 200 to focus on a subject. For example, the focus adjustment unit 600 may move the lens module 200 by generating a driving force in the optical axis (Z-axis) direction.

The focus adjustment unit 600 may include a first magnet 610 and a first coil 630. The first magnet 610 and the first coil 630 may be disposed to face each other in a direction perpendicular to the optical axis (Z-axis).

The first magnet 610 may be mounted on the lens module 200. As an example, the first magnet 610 may be mounted on one side surface of the holder 230 of the lens module 200.

One surface (e.g., a surface facing the first coil 630) of the first magnet 610 may be magnetized to have both an N pole and an S pole. As an example, an N pole, a neutral region, and an S pole may be sequentially provided along the optical axis (Z-axis) direction on the one surface of the first magnet 610 facing the first coil 630.

The first coil 630 may be disposed to face the first magnet 610. For example, the first coil 630 may be disposed to face the first magnet 610 in a direction perpendicular to the optical axis (Z-axis).

The first coil 630 may be disposed on a connection substrate 1000, and a portion of the connection substrate 1000 on which the first coil 630 may be mounted is mounted on the carrier 400′. The first coil 630 may be disposed on one surface of the connection substrate 1000. The connection substrate 1000 is mounted on a side surface of the carrier 400′ in such a manner that the first magnet 610 and the first coil 630 face each other in a direction perpendicular to the optical axis (Z-axis).

The carrier 400′ may have a through-hole penetrating the side surface of the carrier 400′, and the first coil 630 disposed on the connection substrate 1000 may directly face the first magnet 610 through the through-hole.

At the time of adjusting a focus, the first magnet 610 may be a movable member moving in the optical axis (Z-axis) direction together with the lens module 200, and the first coil 630 may be a fixed member fixed to the connection substrate 1000.

When power is applied to the first coil 630, the lens module 200 may be moved in the optical axis (Z-axis) direction by an electromagnetic force generated between the first magnet 610 and the first coil 630.

A first ball member B1 may be disposed between the lens module 200 and the carrier 400′. For example, the first ball member B1 may be disposed between the lens module 200 and the carrier 400′ to reduce friction when the lens module 200 is moved.

The first ball member B1 may include a plurality of balls arranged along the optical axis (Z-axis) direction. The plurality of balls may be moved in a rolling manner in the optical axis (Z-axis) direction when the lens module 200 is moved in the optical axis (Z-axis) direction.

The first ball member B1 may include a first ball group BG1 and a second ball group BG2, and each of the first ball group BG1 and the second ball group BG2 may include one or more balls. The first ball group BG1 and the second ball group BG2 may be disposed to be spaced apart from each other in a direction perpendicular to the optical axis (Z-axis).

A first yoke 650 may be disposed on the carrier 400′. The first yoke 650 may be disposed at a position facing the first magnet 610. For example, the first coil 630 may be disposed on one surface of the connection substrate 1000, and the first yoke 650 may be disposed on the other surface of the connection substrate 1000.

The first magnet 610 and the first yoke 650 may generate an attractive force therebetween. For example, the first yoke 650 may be made of a magnetic material. The attractive force may act in a direction perpendicular to the optical axis (Z-axis) between the first magnet 610 and the first yoke 650.

The first ball member B1 may be in contact with each of the lens module 200 and the carrier 400′ due to the attractive force generated between the first magnet 610 and the first yoke 650.

Guides grooves may be formed in each of the surfaces of the lens module 200 and the carrier 400′ facing each other. For example, a first guide groove g1 accommodating the first ball group BG1 and a second guide groove g2 accommodating the second ball group BG2 may be formed in each of the surfaces of the lens module 200 and the carrier 400′ facing each other.

Each of the first guide groove g1 and the second guide groove g2 may extend in the optical axis (Z-axis) direction.

The first ball group BG1 and the second ball group BG2 may be disposed to be spaced apart from each other in the first axis (X-axis) direction. The number of balls in the first ball group BG1 and the number of balls in the second ball group BG2 may be different. Specifically, the number of balls included in the first ball group BG1 may be greater than the number of balls included in the second ball group BG2.

For example, the first ball group BG1 may include two or more balls disposed along the optical axis (Z-axis) direction, and the second ball group BG2 may include a smaller number of balls than the number of balls included in the first ball group BG1.

On the premise that the number of balls belonging to the first ball group BG1 and the number of balls belonging to the second ball group BG2 are different, the number of balls belonging to each ball group may be changed. Hereinafter, for convenience of explanation, the description will be made based on an embodiment in which the first ball group BG1 includes four balls and the second ball group BG2 includes two balls.

Among the four balls included in the first ball group BG1, the two outermost balls in the optical axis (Z-axis) direction may have the same diameter, and the two balls disposed between the outermost balls may have a smaller diameter than the outermost balls.

The two balls included in the second ball group BG2 may have the same diameter.

Among the four balls included in the first ball group BG1, each of the two outermost balls in the optical axis (Z-axis) direction may be in contact with the carrier 400′ at two points and in contact with the lens module 200 at two points.

Each of the two balls in the second ball group BG2 may be in contact with the carrier 400′ at one point and in contact with the lens module 200 at two points (or vice versa).

The first ball group BG1 and the first guide groove g1 may function as a main guide that guides a movement of the lens module 200 in the optical axis (Z-axis) direction, and the second ball group BG2 and the second guide groove g2 may function as an auxiliary guide that supports a movement of the lens module 200 in the optical axis (Z-axis) direction.

Either one or both of the first ball group BG1 and the second ball group BG2 may be disposed to overlap the reflective member 300 in a direction perpendicular to the optical axis (Z-axis) direction. For example, the first ball group BG1 may be disposed to overlap the reflective member 300 in the second axis (Y-axis) direction.

In an embodiment, an auxiliary yoke (not shown) may be disposed at a position facing the first magnet 610. For example, the auxiliary yoke may be disposed on the connection substrate 1000 to face the first magnet 610. In addition, the auxiliary yoke may be disposed on an inner side of the first coil 630.

The auxiliary yoke may be located closer to the first ball group BG1 than to the second ball group BG2. The auxiliary yoke may be made of a material capable of generating an attractive force with the first magnet 610.

Accordingly, a central point of a resultant force of the attractive force generated between the first magnet 610 and the first yoke 650 and the attractive force generated between the first magnet 610 and the auxiliary yoke may be located closer to the first ball group BG1 than to the second ball group BG2.

In an embodiment, the camera module 5 may detect a position of the lens module 200 in the optical axis (Z-axis) direction.

To this end, a first position sensor 670 may be provided. The first position sensor 670 may be disposed on the connection substrate 1000 to face the first magnet 610. The first position sensor 670 may be a Hall sensor.

The camera module 5 may stabilize an optical image at the time of capturing the image by moving the carrier 400′ in a direction perpendicular to the optical axis (Z-axis). To this end, the camera module 5 may include an optical image stabilization unit 700 moving the carrier 400′ in a direction perpendicular to the optical axis (Z-axis).

The guide frame 500 and the carrier 400′ may be sequentially accommodated in the housing 100. For example, the guide frame 500 may be disposed between the carrier 400′ and the housing 100.

The guide frame 500 and the carrier 400′ may be moved together in one direction perpendicular to the optical axis (Z-axis) by a driving force generated by the optical image stabilization unit 700, and the carrier 400′ may be moved relative to the guide frame 500 in another direction perpendicular to the optical axis (Z-axis) by another driving force generated by the optical image stabilization unit 700.

For example, the guide frame 500 and the carrier 400′ may be moved together in the first axis (X-axis) direction perpendicular to the optical axis (Z-axis), and the carrier 400′ may be moved relative to the guide frame 500 in the second axis (Y-axis) direction.

Since the lens module 200 is disposed inside the carrier 400′, the lens module 200 may be moved together with the carrier 400′.

For example, the carrier 400′ and the lens module 200 may be moved together in the first axis (X-axis) direction and in the second axis (Y-axis) direction.

The optical image stabilization unit 700 may include a first sub-stabilization unit 710 and a second sub-stabilization unit 730. The first sub-stabilization unit 710 may generate a driving force in the first axis (X-axis) direction, and the second sub-stabilization unit 730 may generate driving force in the second axis (Y-axis) direction.

The first sub-stabilization unit 710 may include a second magnet 711 and a second coil 713. The second magnet 711 and the second coil 713 may be disposed to face each other in the first axis (X-axis) direction.

The second magnet 711 may be disposed on the carrier 400′. For example, the second magnet 711 may be mounted on one side surface of the carrier 400′.

One surface of the second magnet 711 may be magnetized to have an N pole or an S pole. The second magnet 711 may have a length extending in the second axis (Y-axis) direction.

The other surface of the second magnet 711 may be magnetized to have a polarity opposite to the polarity of the one surface of the second magnet 711.

The second coil 713 may be disposed to face the second magnet 711. For example, the second coil 713 may be disposed to face the second magnet 711 in the first axis (X-axis) direction.

The second coil 713 may include one coil, and may have a donut-like shape with a hole.

At the time of stabilizing an optical image, the second magnet 711 may be a movable member mounted on the carrier 400′, and the second coil 713 may be a fixed member fixed to the housing 100.

When power is applied to the second coil 713, the carrier 400′ and the guide frame 500 may be moved in the first axis (X-axis) direction by an electromagnetic force generated between the second magnet 711 and the second coil 713.

The second magnet 711 and the second coil 713 may generate a driving force in a direction in which they face each other (e.g., the first axis (X-axis) direction).

The second sub-stabilization unit 730 may include a third magnet 731 and a third coil 733. The third magnet 731 and the third coil 733 may be disposed to face each other in the second axis (Y-axis) direction.

The third magnet 731 may be disposed on the carrier 400′. For example, the third magnet 731 may be mounted on another side surface of the carrier 400′.

The side surface and the other side surface of the carrier 400′ may be perpendicular to each other on a plane perpendicular to the optical axis (Z-axis).

One surface of the third magnet 731 may be magnetized to have an N pole or an S pole. The third magnet 731 may have a length extending in the first axis (X-axis) direction.

The other surface of the third magnet 731 may be magnetized to have a polarity opposite to the polarity of the one surface of the third magnet 731.

The third coil 733 may be disposed to face the third magnet 731. For example, the third coil 733 may be disposed to face the third magnet 731 in the second axis (Y-axis) direction.

The third coil 733 may include one coil, and may have a donut-like shape with a hole.

The second coil 713 and the third coil 733 may be disposed on a substrate 900. As an example, the second coil 713 and the third coil 733 may be disposed on the substrate 900 to face the second magnet 711 and the third magnet 731, respectively.

The substrate 900 is mounted on side surfaces of the housing 100, and the second coil 713 and the third coil 733 may directly face the second magnet 711 and the third magnet 731 through through-holes provided in the housing 100.

At the time of stabilizing an optical image, the third magnet 731 may be a movable member mounted on the carrier 400′, and the third coil 733 may be a fixed member fixed to the housing 100.

When power is applied to the third coil 733, the carrier 400′ may be moved in the second axis (Y-axis) direction by an electromagnetic force generated between the third magnet 731 and the third coil 733.

The third magnet 731 and the third coil 733 may generate a driving force in a direction in which they face each other (e.g., the second axis (Y-axis) direction).

The second magnet 711 and the third magnet 731 may be disposed perpendicular to each other on a plane perpendicular to the optical axis (Z-axis), and the second coil 713 and the third coil 733 may also be disposed perpendicular to each other on the plane perpendicular to the optical axis (Z-axis).

The camera module 5 may include a plurality of ball members supporting the guide frame 500 and the carrier 400′. The plurality of ball members may function to guide movements of the guide frame 500 and the carrier 400′ during an optical image stabilizing process. The plurality of ball members may also function to maintain gaps between the housing 100, the guide frame 500, and the carrier 400′.

The plurality of ball members may include a second ball member B2 and a third ball member B3.

The second ball member B2 may guide movements of the guide frame 500 and the carrier 400′ in the first axis (X-axis) direction, and the third ball member B3 may guide a movement of the carrier 400′ in the second axis (Y-axis) direction.

As an example, the second ball member B2 may move in a rolling manner in the first axis (X-axis) direction when a driving force is generated in the first axis (X-axis) direction. Accordingly, the second ball member B2 may guide movements of the guide frame 500 and the carrier 400′ in the first axis (X-axis) direction.

The third ball member B3 may move in a rolling manner in the second axis (Y-axis) direction when a driving force is generated in the second axis (Y-axis) direction. Accordingly, the third ball member B3 may guide a movement of the carrier 400′ in the second axis (Y-axis) direction.

The second ball member B2 may include a plurality of balls disposed between the housing 100 and the guide frame 500, and the third ball member B3 may include a plurality of balls disposed between the guide frame 500 and the carrier 400′.

For example, each of the second ball member B2 and the third ball member B3 may include four balls.

A third guide groove g3 accommodating the second ball member B2 may be formed in either one or both of the surfaces of the housing 100 and the guide frame 500 facing each other in the optical axis (Z-axis) direction. The third guide groove g3 may include a plurality of grooves corresponding to the plurality of balls of the second ball member B2.

The second ball member B2 may be accommodated in the third guide groove g3, and inserted between the housing 100 and the guide frame 500.

In a state in which the second ball member B2 is accommodated in the third guide groove g3, the second ball member B2 may be moved only in the first axis (X-axis) direction, while its movements in the optical axis (Z-axis) direction and in the second axis (Y-axis) direction are restricted. As an example, the second ball member B2 may move in a rolling manner only in the first axis (X-axis) direction.

To this end, the planar shape of each of the plurality of grooves of the third guide groove g3 may be a rectangle having a length extending in the first axis (X-axis) direction.

A fourth guide groove g4 accommodating the third ball member B3 may be formed in either one or both of the surfaces of the guide frame 500 and the carrier 400′ facing each other in the optical axis (Z-axis) direction. The fourth guide groove g4 may include a plurality of grooves corresponding to the plurality of balls of the third ball member B3.

The third ball member B3 may be accommodated in the fourth guide groove g4, and inserted between the guide frame 500 and the carrier 400′.

In a state in which the third ball member B3 is accommodated in the fourth guide groove g4, the third ball member B3 may be moved only in the second axis (Y-axis) direction, while its movements in the optical axis (Z-axis) direction and in the first axis (X-axis) direction are restricted. As an example, the third ball member B3 may move in a rolling manner only in the second axis (Y-axis) direction.

To this end, the planar shape of each of the plurality of grooves of the fourth guide groove g4 may be a rectangle having a length extending in the second axis (Y-axis) direction.

When a driving force is generated in the first axis (X-axis) direction, the guide frame 500 and the carrier 400′ may move together in the first axis (X-axis) direction. In addition, the lens module 200 may also move in the first axis (X-axis) direction together with the carrier 400′.

Here, the second ball member B2 may move in a rolling manner along the first axis (X-axis). At this time, a movement of the third ball member B3 may be restricted.

When a driving force is generated in the second axis (Y-axis) direction, the carrier 400′ may be moved relative to the guide frame 500 in the second axis (Y-axis) direction. In addition, the lens module 200 may also move in the second axis (Y-axis) direction together with the carrier 400′.

Here, the third ball member B3 may move in a rolling manner along the second axis (Y-axis). At this time, a movement of the second ball member B2 may be restricted.

In an embodiment, the camera module 5 may detect a position of the lens module 200 in a direction perpendicular to the optical axis (Z-axis).

To this end, a second position sensor (not shown) and a third position sensor (not shown) may be provided. The second position sensor may be disposed on the substrate 900 to face the second magnet 711, and the third position sensor may be disposed on the substrate 900 to face the third magnet 731. The second position sensor and the third position sensor may be Hall sensors.

In the present disclosure, a second yoke (not shown) and a third yoke (not shown) may be provided to keep the housing 100 and the guide frame 500 in contact with the second ball member B2, and keep the guide frame 500 and the carrier 400′ in contact with the third ball member B3.

The second yoke and the third yoke may be fixed to the housing 100, and may be disposed to face the second magnet 711 and the third magnet 731 in the optical axis (Z-axis) direction.

Therefore, attractive forces may be generated in the optical axis (Z-axis) direction between the second yoke and the second magnet 711 and between the third yoke and the third magnet 731.

Due to the attractive forces generated between the second and third yokes and the second and third magnets 711 and 731, the carrier 400′ and the guide frame 500 may be pressed in a direction toward the second yoke and the third yoke, making it possible to keep the carrier 400′ and the guide frame 500 in contact with the second ball member B2 and the third ball member B3.

The second yoke and the third yoke may be made of a material capable of generating an attractive force with the second magnet 711 and the third magnet 731. As an example, the second yoke and the third yoke may be made of a magnetic material.

A stopper 410 may be coupled to the carrier 400′. The stopper 410 may be coupled to the carrier 400′ to cover at least a partial portion of an upper surface of the lens module 200.

The stopper 410 may prevent the lens module 200 from separating from the carrier 400′ due to an external shock or other disturbance.

A buffer member (not shown) having an elastic property may be coupled to an edge portion of the stopper 410.

The first coil 630 of the focus adjustment unit 600 may be disposed on the connection substrate 1000.

Since the connection substrate 1000 is mounted on the carrier 400′, the connection substrate 1000 may move together with the carrier 400′ at the time of stabilizing an optical image. That is, since the connection substrate 1000 is moved at the time of stabilizing an optical image, a configuration is needed to stably supply power to the first coil 630.

Referring to FIG. 26, the connection substrate 1000 may include a mounting portion 1010, a first extension portion 1020, and a second extension portion 1030. The first coil 630 may be disposed on the mounting portion 1010.

The first extension portion 1020 may extend after being bent from one side of the mounting portion 1010. The first extension portion 1020 may be disposed to be spaced apart from a side surface of the carrier 400′, and may extend along the side surface of the carrier 400′. The first extension portion 1020 may be bent at least once, and may be made of a flexible material.

The second extension portion 1030 may extend after being bent from one side of the first extension portion 1020. In addition, the second extension portion 1030 may be connected to the printed circuit board 830 to supply power to the connection substrate 1000.

A partial portion of the second extension portion 1030 may be located inside the housing 100, and the other portion of the second extension portion 1030 may be located outside the housing 100.

A through-hole 140 penetrating a side surface of the housing 100 may be provided in the side surface of the housing 100. The other portion of the second extension portion 1030 may extend to the outside of the housing 100 through the through-hole 140 of the housing 100.

When the carrier 400′ is moved, at least a partial portion of the connection substrate 1000 may be bent.

Therefore, even though the carrier 400′ is moved at the time of stabilizing an optical image, the connection substrate 1000 may stably supply power to the first coil 630.

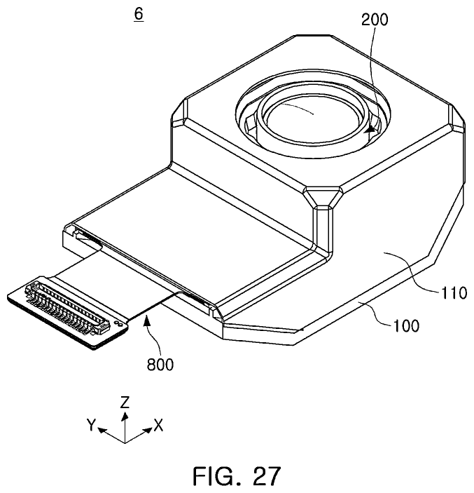

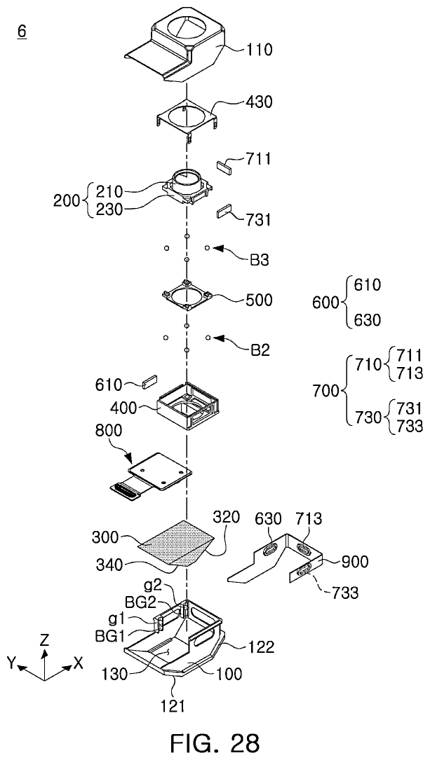

FIG. 27 is a perspective view of a camera module according to another embodiment of the present disclosure, and FIG. 28 is an exploded perspective view of the camera module of FIG. 27.

Referring to FIGS. 27 and 28, a camera module 6 according to another embodiment of the present disclosure may include a lens module 200, a reflective member 300, and a housing 100.

The lens module 200 may include a lens barrel 210 and a holder 230. The lens barrel 210 may have a hollow cylindrical shape, and at least one lens for imaging a subject may be accommodated inside the lens barrel 210. In a case in which a plurality of lenses are arranged, the plurality of lenses may be mounted inside the lens barrel 210 along the optical axis (Z-axis).

The lens barrel 210 may be coupled to the holder 230. The lens barrel 210 and the holder 230 may be moved together.

The housing 100 may have an internal space. In an embodiment, the housing 100 may be shaped like a rectangular box. An opening 130 may be formed in one surface of the housing 100. The internal space of the housing 100 may be exposed to the outside of the housing 100 through the opening 130. The one surface of the housing 100 may be an upper surface of the housing 100 as shown in FIG. 28.

The reflective member 300 may disposed in the internal space of the housing 100. In addition, the lens module 200 may be disposed in front of the reflective member 300. Here, the expression “in front of” may refer to a positive optical axis (Z-axis) direction (+Z-axis direction) with respect to the reflective member 300. For example, the lens module 200 may be spaced apart from the reflective member 300 upward in the optical axis (Z-axis) direction.

Therefore, light may be incident on the reflective member 300 after passing through the lens module 200.

The lens module 200 may be moved in one or more of three axial directions intersecting each other. In addition, the lens module 200 may be moved relative to the reflective member 300.

For example, the lens module 200 may be moved in the optical axis (Z-axis) direction for focus adjustment. In addition, the lens module 200 may be moved in a direction perpendicular to the optical axis (Z-axis) for optical image stabilization.

In an embodiment, the three axial directions intersecting each other may be the optical axis (Z-axis) direction, the first axis (X-axis) direction, and the second axis (Y-axis) direction.

The camera module 6 may further include a carrier 400 and a guide frame 500.

The carrier 400 may be disposed inside the housing 100, and may be moved relative to the housing 100 in the optical axis (Z-axis) direction.

The lens module 200 may be disposed on the carrier 400, and the carrier 400 and the lens module 200 may be moved together in the optical axis (Z-axis) direction. Accordingly, the camera module 6 may adjust a focus.

In addition, the lens module 200 may be moved in a direction perpendicular to the optical axis (Z-axis) direction to stabilize an optical image at the time of capturing the image.

The guide frame 500 may be disposed between the carrier 400 and the lens module 200. The guide frame 500 may function to guide the lens module 200 to be moved in a direction perpendicular to the optical axis (Z-axis) direction.

The guide frame 500 may be a rectangular frame having an opening in the optical axis (Z-axis) direction. In an embodiment, the planar shape of the guide frame 500 may be approximately a ‘▭’ shape.

The carrier 400 and the guide frame 500 may be disposed in front of the reflective member 300. That is, the carrier 400 and the guide frame 500 may be disposed to be higher than the reflective member 300 in the optical axis (Z-axis) direction.

The lens module 200 may be accommodated in the housing 100. For example, the lens module 200 may be disposed inside the opening 130 formed in the one surface of the housing 100. In an embodiment, the carrier 400 may be disposed inside the housing 100, and the lens module 200 may be accommodated inside the carrier 400.

The camera module 6 may adjust a focus by moving the lens module 200 in the optical axis (Z-axis) direction, and may stabilize an optical image at the time of capturing the image by moving the lens module 200 in a direction perpendicular to the optical axis (Z-axis).

The camera module 6 may further include a focus adjustment unit 600 moving the lens module 200 in the optical axis (Z-axis) direction, and an optical image stabilization unit 700 moving the lens module 200 in a direction perpendicular to the optical axis (Z-axis) direction.

The camera module 6 may further include an image sensor module 800 and a case 110.

Referring to FIGS. 10 and 11, the image sensor module 800 may include an image sensor 810 and a printed circuit board 830 connected to the image sensor 810, and may further include a sensor housing 850.

The image sensor 810 may convert light incident through the lens module 200 into an electric signal. As an example, the image sensor 810 may be a charge-coupled device (CCD) or a complementary metal-oxide-semiconductor (CMOS) device.

The electric signal converted by the image sensor 810 may be output as an image through a display unit of a portable electronic device in which the camera module 6 is mounted.

The image sensor 810 may be fixed to the printed circuit board 830, and may be electrically connected to the printed circuit board 830 by wire bonding.

The image sensor 810 may have an imaging surface on which light is received, and the imaging surface of the image sensor 810 may be a surface intersecting the optical axis (Z-axis) direction. The image sensor 810 may be disposed to be spaced apart from the reflective member 300. For example, the image sensor 810 may be spaced apart from the reflective member 300 upward in the optical axis (Z-axis) direction.

In an embodiment, both the lens module 200 and the image sensor 810 may be disposed to be higher than the reflective member 300 in the optical axis (Z-axis) direction. For example, the lens module 200 and the image sensor 810 may be disposed closer to an object than the reflective member 300 is.

The image sensor module 800 may be mounted in the housing 100. As an example, the image sensor module 800 may be disposed in the opening 130 formed in the one surface of the housing 100.

In an embodiment, the sensor housing 850 may be coupled to the printed circuit board 830, and the image sensor 810 may be disposed in an internal space of the sensor housing 850. In addition, either one or both of the sensor housing 850 and the printed circuit board 830 may be coupled to the housing 100.

The lens module 200 and the image sensor 810 may be disposed in the opening 130 of the housing 100, and may be disposed to be spaced apart from each other in a direction (e.g., the first axis (X-axis) direction) intersecting the optical axis (Z-axis) direction.

The case 110 may be coupled to the housing 100 to cover an outer surface of the housing 100, and may function to protect the internal components of the camera module 6.

The reflective member 300 may have one surface facing the optical axis (Z-axis) direction. The one surface of the reflective member 300 may be a surface intersecting the optical axis (Z-axis) direction. As an example, the one surface of the reflective member 300 may be an upper surface of the reflective member 300 in FIG. 28.

The lens module 200 and the image sensor 810 may be disposed closer to an object than the reflective member 300 is, and may be spaced apart from each other in a direction intersecting the optical axis (Z-axis) direction. That is, among the lens module 200, the image sensor 810, and the reflective member 300, the lens module 200 and the image sensor 810 may be the closest ones to the object, and the reflective member 300 may be the farthest one from the object.

In an embodiment, the lens module 200 may face a partial portion of the one surface (e.g., the upper surface) of the reflective member 300, and the image sensor 810 may face another partial portion of the one surface (e.g., the upper surface) of the reflective member 300.

The reflective member 300 may have one or more reflection surfaces. Since light having passed through the lens module 200 enters the image sensor 810 after being reflected by the reflective member 300, a long optical path can be formed within a limited space.

In addition, since the lens module 200 is disposed in front of the reflective member 300, the Fno (the F-number of the camera module 6) can be reduced to capture a bright image.

Referring to FIG. 12, in an embodiment, the reflective member 300 may be in the form of a trapezoidal prism. The reflective member 300 may include an incident surface 310 on which light is incident, a first reflection surface 320 reflecting light having passed through the incident surface 310, a second reflection surface 330 reflecting light reflected from the first reflection surface 320, a third reflection surface 340 reflecting light reflected from the second reflection surface 330, and an emission surface 350 from which light reflected from the third reflection surface 340 is emitted. Light having passed through the emission surface 350 may be incident on the image sensor 810.

The image sensor 810 being disposed closer to the object than the reflective member 300 is may mean that the image sensor 810 is disposed closer to the object than the emission surface 350 of the reflective member 300 is.

The incident surface 310, the second reflection surface 330, and the emission surface 350 may be one surface extending on the same plane.

Each of the first reflection surface 320 and the third reflection surface 340 may be inclined with respect to the second reflection surface 330.

A partial portion of the reflective member 300 may be disposed below the carrier 400. In an embodiment, the incident surface 310 and the first reflection surface 320 of the reflective member 300 may be disposed below the carrier 400.

Referring to FIG. 28, at least a partial portion 120 of a bottom surface of the housing 100 facing the image sensor 810 in the optical axis (Z-axis) direction may be inclined with respect to the optical axis (Z-axis) direction. That is, at least a partial portion of the bottom surface of the housing 100 may be an inclined surface. For example, a partial portion of the bottom surface of the housing 100 may include a first inclined surface 121. In an embodiment, the first inclined surface 121 of the bottom surface of the housing 100 may face the third reflection surface 340 of the reflective member 300.

In addition, another portion of the bottom surface of the housing 100 may also be an inclined surface. For example, another portion of the bottom surface of the housing 100 may include a second inclined surface 122. The first inclined surface 121 and the second inclined surface 122 of the bottom surface of the housing 100 may be disposed to be spaced apart from each other in the first axis (X-axis) direction. The first inclined surface 121 and the second inclined surface 122 may be inclined to approach each other in the optical axis (Z-axis) direction as they slant downward.

In an embodiment, the second inclined surface 122 of the bottom surface of the housing 100 may face the first reflection surface 320 of the reflective member 300.

At least a partial portion of the third reflection surface 340 may be located between the first inclined surface 121 of the housing 100 and the image sensor 810. The third reflection surface 340 and the first inclined surface 121 of the housing 100 may be parallel to each other. For example, an inclination angle of the third reflection surface 340 with respect to the optical axis (Z-axis) direction and an inclination angle of the first inclined surface 121 of the housing 100 with respect to the optical axis (Z-axis) direction may be the same.

At least a partial portion of the first reflection surface 320 may be located between the second inclined surface 122 of the housing 100 and the lens module 200. The first reflection surface 320 and the second inclined surface 122 of the housing 100 may be parallel to each other. For example, an inclination angle of the first reflection surface 320 with respect to the optical axis (Z-axis) direction and an inclination angle of the second inclined surface 122 of the housing 100 with respect to the optical axis (Z-axis) direction may be the same.

The camera module 6 may move the lens module 200 to focus on a subject. To this end, the camera module 6 may include a focus adjustment unit 600.

The focus adjustment unit 600 may move the carrier 400 by generating a driving force in the optical axis (Z-axis) direction. Since the lens module 200 is disposed on the carrier 400, the carrier 400 and the lens module 200 may be moved together in the optical axis (Z-axis) direction by the driving force generated by the focus adjustment unit 600. In addition, since the guide frame 500 is disposed on the carrier 400, the guide frame 500 may be moved together with the carrier 400 in the optical axis (Z-axis) direction by the driving force generated by the focus adjustment unit 600.

The focus adjustment unit 600 may include a first magnet 610 and a first coil 630. The first magnet 610 and the first coil 630 may be disposed to face each other in a direction perpendicular to the optical axis (Z-axis).

The focus adjustment unit 600 may be disposed spaced apart from the reflective member 300 upward in the optical axis (Z-axis) direction. That is, the focus adjustment unit 600 may be disposed to be higher than the reflective member 300 in the optical axis (Z-axis) direction.

The first magnet 610 may be mounted on the carrier 400. As an example, the first magnet 610 may be mounted on one side surface of the carrier 400. A back yoke may be disposed between one side surface of the carrier 400 and the first magnet 610. The back yoke may be made of a magnetic material. The back yoke makes it possible to prevent a magnetic field of the first magnet 610 from leaking into the carrier 400.

One surface (e.g., a surface facing the first coil 630) of the first magnet 610 may be magnetized to have both an N pole and an S pole. As an example, an N pole, a neutral region, and an S pole may be sequentially provided along the optical axis (Z-axis) direction on the one surface of the first magnet 610 facing the first coil 630.

The first coil 630 may be disposed to face the first magnet 610. For example, the first coil 630 may be disposed to face the first magnet 610 in a direction perpendicular to the optical axis (Z-axis).

The first coil 630 may be disposed on a substrate 900, and the substrate 900 may be mounted on the housing 100 in such a manner that the first magnet 610 and the first coil 630 face each other in a direction perpendicular to the optical axis (Z-axis). As an example, the first coil 630 may be disposed on one surface of the substrate 900. The substrate 900 may be mounted on a side surface of the housing 100 in such a manner that the first magnet 610 and the first coil 630 face each other in a direction perpendicular to the optical axis (Z-axis).

The housing 100 may have a through-hole penetrating the housing 100, and the first coil 630 disposed on the substrate 900 may directly face the first magnet 610 through the through-hole.

At the time of adjusting a focus, the first magnet 610 may be a movable member mounted on the carrier 400 and moving in the optical axis (Z-axis) direction together with the carrier 400, and the first coil 630 may be a fixed member fixed to the substrate 900.

When power is applied to the first coil 630, the carrier 400 may be moved in the optical axis (Z-axis) direction by an electromagnetic force generated between the first magnet 610 and the first coil 630.

Since the lens module 200 is disposed on the carrier 400, the lens module 200 may also be moved in the optical axis (Z-axis) direction by the movement of the carrier 400.

A first ball member B1 may be disposed between the carrier 400 and the housing 100. For example, the first ball member B1 may be disposed between the carrier 400 and the housing 100 to reduce friction when the carrier 400 is moved.

The first ball member B1 may include a plurality of balls arranged along the optical axis (Z-axis) direction. The plurality of balls may be moved in a rolling manner in the optical axis (Z-axis) direction when the carrier 400 is moved in the optical axis (Z-axis) direction.

The first ball member B1 may include a first ball group BG1 and a second ball group BG2, and each of the first ball group BG1 and the second ball group BG2 may include one or more balls. The first ball group BG1 and the second ball group BG2 may be disposed to be spaced apart from each other in a direction perpendicular to the optical axis (Z-axis).

A first yoke (not shown) may be disposed on the housing 100. The first yoke may be disposed at a position facing the first magnet 610. For example, the first coil 630 may be disposed on one surface of the substrate 900, and the first yoke may be disposed on the other surface of the substrate 900.

The first magnet 610 and the first yoke may generate an attractive force therebetween. For example, the first yoke may be made of a magnetic material. The attractive force may act in a direction perpendicular to the optical axis (Z-axis) between the first magnet 610 and the first yoke.

The first ball member B1 may be in contact with each of the carrier 400 and the housing 100 due to the attractive force generated between the first magnet 610 and the first yoke.

Guides grooves may be formed in each of the surfaces of the carrier 400 and the housing 100 facing each other. For example, a first guide groove g1 accommodating the first ball group BG1 and a second guide groove g2 accommodating the second ball group BG2 may be formed in each of the surfaces of the carrier 400 and the housing 100 facing each other.

Each of the first guide groove g1 and the second guide groove g2 may extend in the optical axis (Z-axis) direction.

The first ball group BG1 and the second ball group BG2 may be disposed to be spaced apart from each other in the first axis (X-axis) direction. The number of balls in the first ball group BG1 and the number of balls in the second ball group BG2 may be different. Specifically, the number of balls included in the first ball group BG1 may be greater than the number of balls included in the second ball group BG2.

For example, the first ball group BG1 may include two or more balls disposed along the optical axis (Z-axis) direction, and the second ball group BG2 may include a smaller number of balls than the number of balls included in the first ball group BG1.

On the premise that the number of balls belonging to the first ball group BG1 and the number of balls belonging to the second ball group BG2 are different, the number of balls belonging to each ball group may be changed. Hereinafter, for convenience of explanation, the description will be made based on an embodiment in which the first ball group BG1 includes two balls and the second ball group BG2 includes one ball.

Each of the two balls in the first ball group BG1 may be in contact with the carrier 400 at two points and in contact with the housing 100 at two points.

The one ball in the second ball group BG2 may be in contact with the carrier 400 at one point and in contact with the housing 100 at two points (or vice versa).

The first ball group BG1 and the first guide groove g1 may function as a main guide that guides a movement of the carrier 400 in the optical axis (Z-axis) direction, and the second ball group BG2 and the second guide groove g2 may function as an auxiliary guide that supports a movement of the carrier 400 in the optical axis (Z-axis) direction.

The first ball group BG1 and the second ball group BG2 may be disposed to be higher than the reflective member 300 in the optical axis (Z-axis) direction.

In an embodiment, an auxiliary yoke (not shown) may be disposed at a position facing the first magnet 610. For example, the auxiliary yoke may be disposed on the substrate 900 to face the first magnet 610. In addition, the auxiliary yoke may be disposed on an inner side of the first coil 630.

The auxiliary yoke may be located closer to the first ball group BG1 than to the second ball group BG2. The auxiliary yoke may be made of a material capable of generating an attractive force with the first magnet 610.

Accordingly, a central point of a resultant force of the attractive force generated between the first magnet 610 and the first yoke and the attractive force generated between the first magnet 610 and the auxiliary yoke may be located closer to the first ball group BG1 than to the second ball group BG2.

In an embodiment, the camera module 6 may detect a position of the carrier 400 in the optical axis (Z-axis) direction.

To this end, a first position sensor (not shown) may be provided. The first position sensor may be disposed on the substrate 900 to face the first magnet 610. The first position sensor may be a Hall sensor.

The camera module 6 may stabilize an optical image at the time of capturing the image by moving the lens module 200 in a direction perpendicular to the optical axis (Z-axis). To this end, the camera module 6 may include an optical image stabilization unit 700 moving the lens module 200 in a direction perpendicular to the optical axis (Z-axis).

The guide frame 500 and the lens module 200 may be sequentially accommodated in the carrier 400. For example, the guide frame 500 may be disposed between the carrier 400 and the lens module 200.

The guide frame 500 and the lens module 200 may be moved together in one direction perpendicular to the optical axis (Z-axis) by a driving force generated by the optical image stabilization unit 700, and the lens module 200 may be moved relative to the guide frame 500 in another direction perpendicular to the optical axis (Z-axis) by another driving force generated by the optical image stabilization unit 700.

For example, the guide frame 500 and the lens module 200 may be moved together in the first axis (X-axis) direction perpendicular to the optical axis (Z-axis), and the lens module 200 may be moved relative to the guide frame 500 in the second axis (Y-axis) direction perpendicular to both the optical axis (Z-axis) and the first axis (X-axis).

The optical image stabilization unit 700 may include a first sub-stabilization unit 710 and a second sub-stabilization unit 730. The first sub-stabilization unit 710 may generate a driving force in the first axis (X-axis) direction, and the second sub-stabilization unit 730 may generate a driving force in the second axis (Y-axis) direction. The first sub-stabilization unit 710 and the second sub-stabilization unit 730 may be disposed to be spaced apart from the reflective member 300 upward in the optical axis (Z-axis) direction. That is, the optical image stabilization unit 700 may be disposed to be higher than the reflective member 300 in the optical axis (Z-axis) direction.

The first sub-stabilization unit 710 may include a second magnet 711 and a second coil 713. The second magnet 711 and the second coil 713 may be disposed to face each other in the first axis (X-axis) direction.

The second magnet 711 may be disposed on the lens module 200. For example, the second magnet 711 may be mounted on one side surface of the holder 230.

One surface (e.g., a surface facing the second coil 713) of the second magnet 711 may be magnetized to have an N pole or an S pole. The second magnet 711 may have a length extending in the second axis (Y-axis) direction.

The other surface of the second magnet 711 may be magnetized to have a polarity opposite to the polarity of the one surface of the second magnet 711.

The second coil 713 may be disposed to face the second magnet 711. For example, the second coil 713 may be disposed to face the second magnet 711 in the first axis (X-axis) direction.

The second coil 713 may be disposed on the substrate 900, and the substrate 900 may be mounted on the housing 100 in such a manner that the second magnet 711 and the second coil 713 face each other in the first axis (X-axis) direction.

The housing 100 may have a through-hole, and the second coil 713 disposed on the substrate 900 may directly face the second magnet 711 through the through-hole.

At the time of stabilizing an optical image, the second magnet 711 may be a movable member mounted on the lens module 200, and the second coil 713 may be a fixed member fixed to the housing 100.

When power is applied to the second coil 713, the lens module 200 and the guide frame 500 may be moved in the first axis (X-axis) direction by an electromagnetic force generated between the second magnet 711 and the second coil 713.

The second magnet 711 and the second coil 713 may generate a driving force in a direction in which they face each other (e.g., the first axis (X-axis) direction).

The second sub-stabilization unit 730 may include a third magnet 731 and a third coil 733. The third magnet 731 and the third coil 733 may be disposed to face each other in the second axis (Y-axis) direction.

The third magnet 731 may be disposed on the lens module 200. For example, the third magnet 731 may be mounted on another side surface of the holder 230.

One surface (e.g., a surface facing the third coil 733) of the third magnet 731 may be magnetized to have an S pole or an N pole. The third magnet 731 may have a length extending in the first axis (X-axis) direction.

The other surface of the third magnet 731 may be magnetized to have a polarity opposite to the polarity of the one surface of the third magnet 731.

The third coil 733 may be disposed to face the third magnet 731. For example, the third coil 733 may be disposed to face the third magnet 731 in the second axis (Y-axis) direction.

The third coil 733 may be disposed on the substrate 900, and the substrate 900 may be mounted on the housing 100 in such a manner that the third magnet 731 and the third coil 733 face each other in the second axis (Y-axis) direction.

The housing 100 may have a through-hole, and the third coil 733 disposed on the substrate 900 may directly face the third magnet 731 through the through-hole.

At the time of stabilizing an optical image, the third magnet 731 may be a movable member mounted on the lens module 200, and the third coil 733 may be a fixed member fixed to the housing 100.

When power is applied to the third coil 733, the lens module 200 may be moved in the second axis (Y-axis) direction by an electromagnetic force generated between the third magnet 731 and the third coil 733.

The third magnet 731 and the third coil 733 may generate a driving force in a direction in which they face each other (e.g., the second axis (Y-axis) direction).

The second magnet 711 and the third magnet 731 may be disposed perpendicular to each other on a plane perpendicular to the optical axis (Z-axis), and the second coil 713 and the third coil 733 may also be disposed perpendicular to each other on the plane perpendicular to the optical axis (Z-axis).

The first magnet 610 of the focus adjustment unit 600 and the third magnet 731 of the optical image stabilization unit 700 may be disposed to be spaced apart from each other in the second axis (Y-axis) direction.

The camera module 6 according to another embodiment of the present disclosure may include a plurality of ball members supporting the guide frame 500 and the lens module 200. The plurality of ball members may function to guide movements of the guide frame 500 and the lens module 200 during an optical image stabilizing process. The plurality of ball members may also function to maintain gaps between the carrier 400, the guide frame 500, and the lens module 200.

The plurality of ball members may include a second ball member B2 and a third ball member B3. Since the second ball member B2 and the third ball member B3 are similar to those in the other embodiments described above, detailed description thereof will be omitted.

When a driving force is generated in the first axis (X-axis) direction, the guide frame 500 and the lens module 200 may move together in the first axis (X-axis) direction. Here, the second ball member B2 may move in a rolling manner along the first axis (X-axis). At this time, a movement of the third ball member B3 may be restricted.

When a driving force is generated in the second axis (Y-axis) direction, the lens module 200 may be moved relative to the guide frame 500 in the second axis (Y-axis) direction. Here, the third ball member B3 may move in a rolling manner along the second axis (Y-axis). At this time, a movement of the second ball member B2 may be restricted.

In an embodiment, the camera module 6 may detect a position of the lens module 200 in a direction perpendicular to the optical axis (Z-axis).

To this end, a second position sensor (not shown) and a third position sensor (not shown) may be provided. The second position sensor may be disposed on the substrate 900 to face the second magnet 711, and the third position sensor may be disposed on the substrate 900 to face the third magnet 731. The second position sensor and the third position sensor may be Hall sensors.

In the present disclosure, a second yoke (not shown) and a third yoke (not shown) may be provided to keep the carrier 400 and the guide frame 500 in contact with the second ball member B2, and keep the guide frame 500 and the lens module 200 in contact with the third ball member B3.

The second yoke and the third yoke may be fixed to the carrier 400, and may be disposed to face the second magnet 711 and the third magnet 731 in the optical axis (Z-axis) direction. For example, the second yoke and third yoke may be disposed on a bottom surface of the carrier 400.

Therefore, attractive forces may be generated in the optical axis (Z-axis) direction between the second yoke and the second magnet 711 and between the third yoke and the third magnet 731.

Due to the attractive force generated between the second yoke and the second magnet 711 and the attractive force generated between the third yoke and the third magnet 731, the lens module 200 and the guide frame 500 may be pressed in a direction toward the second yoke and the third yoke, making it possible to keep the guide frame 500 and the lens module 200 in contact with the second ball member B2 and the third ball member B3.

The second yoke and the third yoke may be made of a material capable of generating an attractive force between the second magnet 711 and the third magnet 731. As an example, the second yoke and the third yoke may be made of a magnetic material.

Referring to FIG. 28, a stopper 430 may be coupled to the carrier 400. The stopper 430 may be coupled to the carrier 400 to cover at least a partial portion of an upper surface of the lens module 200. For example, the stopper 430 may cover at least a partial portion of the upper surface of the holder 230.

The stopper 430 may prevent the guide frame 500 and the lens module 200 from separating from the carrier 400 due to an external shock or other disturbance.

A buffer member (not shown) having an elastic property may be coupled to an edge portion of the stopper 430.

As set forth above, according to an embodiments of the present disclosure, the size of the camera module can be reduced.

While this disclosure includes specific examples, it will be apparent after an understanding of the disclosure of this application that various changes in form and details may be made in these examples without departing from the spirit and scope of the claims and their equivalents. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module comprising:
a housing having an internal space;
a reflective member disposed in the internal space;
a lens barrel spaced apart from the reflective member, and configured to be movable relative to the reflective member in one or more of three axial directions intersecting each other; and
an image sensor spaced apart from the reflective member, and comprising an imaging surface intersecting an optical axis direction,
wherein the lens barrel and the image sensor are disposed closer to an object than the reflective member is, and are spaced apart from each other in a direction intersecting the optical axis direction.

2. The camera module of claim 1, wherein one surface of the housing comprises one or more openings exposing the internal space to an outside of the housing, and
the lens barrel and the image sensor are disposed in the one or more openings.

3. The camera module of claim 1, wherein the three axial directions are the optical axis direction, a first axis direction perpendicular to the optical axis direction, and a second axis direction perpendicular to both the optical axis direction and the first axis direction, and
the lens barrel and the image sensor are spaced apart from the reflective member upward in the optical axis direction.

4. The camera module of claim 1, further comprising:
a holder coupled to the lens barrel;
a carrier accommodating the holder; and
a focus adjustment unit configured to generate a driving force in the optical axis direction, and comprising a first magnet disposed on the carrier, and a first coil facing the first magnet.

5. The camera module of claim 4, wherein a partial portion of the reflective member is disposed inside the carrier.

6. The camera module of claim 4, wherein a partial portion of the image sensor is disposed inside the carrier.

7. The camera module of claim 4, wherein at least a partial portion of the focus adjustment unit is disposed to overlap the reflective member in a direction perpendicular to the optical axis direction.

8. The camera module of claim 4, wherein a partial portion of the first magnet and a partial portion of the first coil are disposed to overlap the reflective member in a direction in which the first magnet and the first coil face each other.

9. The camera module of claim 4, further comprising a first ball member disposed between the carrier and the housing,
wherein the first ball member comprises a first ball group and a second ball group spaced apart from each other in a direction perpendicular to the optical axis direction, and
a number of balls included in the first ball group is greater than a number of balls included in the second ball group.

10. The camera module of claim 9, wherein either one or both of the first ball group and the second ball group is disposed to overlap the reflective member in a direction perpendicular to the optical axis direction.

11. The camera module of claim 9, wherein a first guide groove accommodating the first ball group and a second guide groove accommodating the second ball group are formed in each of surfaces of the carrier and the housing facing each other, and
a length of the first guide groove in the optical axis direction is longer than a height of the reflective member in the optical axis direction.

12. The camera module of claim 1, further comprising:
a holder coupled to the lens barrel; and
an optical image stabilization unit configured to generate a driving force in a first axis direction and a second axis direction perpendicular to each other while intersecting the optical axis direction, and comprising a second magnet and a third magnet disposed on the holder, and a second coil and a third coil disposed on the housing.

13. The camera module of claim 12, wherein at least a partial portion of the optical image stabilization unit is disposed to overlap the reflective member in the first axis direction and in the second axis direction.

14. The camera module of claim 12, wherein at least a partial portion of each of the second magnet and the second coil is disposed to overlap the reflective member in a direction in which the second magnet and the second coil face each other, and
at least a partial portion of each of the third magnet and the third coil is arranged to overlap the reflective member in a direction in which the third magnet and the third coil face each other.

15. The camera module of claim 12, wherein the optical image stabilization unit is disposed to be higher than the reflective member in the optical axis direction.

16. The camera module of claim 1, wherein at least a partial portion of a bottom surface of the housing facing the image sensor in the optical axis direction is inclined with respect to the optical axis direction.

17. The camera module of claim 1, wherein the reflective member comprises:
an incident surface configured to receive incident light;
a first reflection surface configured to reflect light having passed through the incident surface;
a second reflection surface configured to reflect light reflected from the first reflection surface;
a third reflection surface configured to reflect light reflected from the second reflection surface; and
an emission surface configured to emit light reflected from the third reflection surface, and
the incident surface, the second reflection surface, and the emission surface are parts of one surface extending on a same plane.

18. The camera module of claim 1, further comprising a carrier disposed inside the housing,
wherein the lens barrel is disposed inside the carrier,
the carrier and the lens barrel are configured to be movable together in a first axis direction perpendicular to the optical axis direction and in a second axis direction perpendicular to both the optical axis direction and the first axis direction, and
the lens barrel is configured to be movable relative to the carrier in the optical axis direction.

19. The camera module of claim 18, further comprising:
a holder coupled to the lens barrel;
a focus adjustment unit comprising a first magnet disposed in the holder, and a first coil facing the first magnet; and
a connection substrate disposed on the carrier;
wherein the connection substrate comprises a mounting portion on which the first coil is disposed, a first extension portion bent from the mounting portion and extending along a side surface of the carrier, and a second extension portion bent from the first extension portion and extending to the outside of the housing, and
the first extension portion is made of a flexible material.

20. A camera module comprising:
a housing;
a reflective member disposed in the housing, and comprising one surface intersecting an optical axis direction;
a lens barrel spaced apart from a partial portion of the one surface of the reflective member, and configured to be movable relative to the reflective member in one or more of three axial directions intersecting each other; and
an image sensor facing another partial portion of the one surface of the reflective member, and comprising an imaging surface intersecting the optical axis direction.

21. The camera module of claim 20, wherein the reflective member comprises:
an incident surface configured to receive light having passed through the lens barrel;
a first reflection surface configured to reflect light having passed through the incident surface;
a second reflection surface configured to reflect light reflected from the first reflection surface;
a third reflection surface configured to reflect light reflected from the second reflection surface; and
an emission surface configured to emit light reflected from the third reflection surface, and
the incident surface, the second reflection surface, and the emission surface are parts of the one surface of the reflective member.

22. The camera module of claim 20, wherein at least a partial portion of a bottom surface of the housing facing the image sensor in the optical axis direction is inclined with respect to the optical axis direction.

23. A camera module comprising:
a reflective member comprising one surface comprising an incident surface and an emission surface;
a lens module having an optical axis intersecting the incident surface of the reflective member, the lens module being configured to receive light from an object and to be movable relative to the reflective member; and
an image sensor comprising an imaging surface facing the emission surface of the reflective member,
wherein the lens module and the image sensor are disposed between the reflective member and the object.

24. The camera module of claim 23, wherein the reflective member comprises at three reflective surfaces configured to reflect light from the lens module received through the incident surface to the imaging surface of the image sensor through the emission surface.

25. The camera module of claim 23, further comprising a focus adjustment unit configured to move the lens module in a direction of the optical axis relative to the reflective member; and
an optical image stabilization unit configured to move the lens module in a direction perpendicular to the optical axis.

26. The camera module of claim 25, wherein at least a partial portion of the focus adjustment unit is disposed to overlap the reflective member in a direction perpendicular to the optical axis.

27. The camera module of claim 25, wherein the focus adjustment unit is disposed between the reflective member and the object.

28. The camera module of claim 25, wherein at least a partial portion of the optical image stabilization unit is disposed to overlap the reflective member in a direction perpendicular to the optical axis.

29. The camera module of claim 25, wherein the optical image stabilization unit is disposed between the reflective member and the object.
